(19) United States
(12) Patent Application Publication
(10) Pub. No.: US 2020/0213052 A1
(43) Pub. Date: Jul. 2, 2020

(54) Mobile Communication System, Mobile Device, User Equipment, Network Node, NodeB, Circuits, Apparatuses, Methods, Machine Readable Media and Computer Programs for Mobile Devices, User Equipment, Network Nodes, and NodeBs

(71) Applicant: Apple Inc., Cupertino, CA (US)

(72) Inventors: Qian Li, Beaverton, OR (US); Dae Won Lee, Portland, OR (US); Dawei Ying, Hillsboro, OR (US); Song Noh, Hillsboro, OR (US); Hassan Ghozlan, Hillsboro, OR (US); Geng Wu, Portland, OR (US); Honglei Miao, Munich (DE)

(21) Appl. No.: 16/637,936

(22) PCT Filed: Aug. 9, 2018
(86) PCT No.: PCT/US18/45925

§ 371 Date: Feb. 10, 2020

Related U.S. Application Data
(60) Provisional application No. 62/544,623, filed on Aug. 11, 2017.
(60) Provisional application No. 62/555,453, filed on Sep. 7, 2017.

(51) Int. Cl. H04L 5/00; H04W 72/04; H04W 24/10

(52) U.S. Cl. CPC H04L 5/0048; H04W 24/10; H04W 72/042

(57) ABSTRACT

Examples provide a mobile communication system, a mobile device, user equipment, a network node, a NodeB, circuits, apparatuses, methods, machine readable media and computer programs for mobile device, user equipment, network nodes, NodeBs. An apparatus (10) for a user equipment, UE (100), configured to communicate in a mobile communication system (400) comprises one or more interfaces (12) configured to communicate within the mobile communication system (400). The apparatus (10) comprises a control module (14) configured to control the one or more interfaces (12). Then control module (14) is configured to process reference signal configuration information received by the one or more interfaces (12). The reference signal configuration information comprises information on a reference signal radio configuration information resource, the reference signal radio resource specifying at least one reference signal from a group of two or more reference signals. The two or more reference signals differ in at least one element of the group of a time-frequency resource, a sequence, and a cyclic shift. The control module (14) is configured to enable measurements based on the at least one reference signal.

### FIELD

Examples relate to a concept for a mobile communication system, a mobile device, user equipment, a network node, a NodeB, circuits, apparatuses, methods, machine readable media and computer programs for mobile device, user equipment, network nodes, NodeBs and particularly but not exclusively to a concept for configuring cross link interference measurements in a mobile communication system.

### BACKGROUND

Radio environment becomes more and more diverse. While new wireless standards and communication systems get introduced, new wireless service introduce new communication paths, examples are Device-to-Device (D2D) communication, Vehicle-to-Anything (V2X) communication, Car-to-Car (C2C) communication, relaying and multi hop communication over cellular, etc. With these technologies the number of potential interference sources may increase.

### BRIEF DESCRIPTION OF THE FIGURES

Some examples of apparatuses and/or methods will be described in the following by way of example only, and with reference to the accompanying figures, in which

FIG. 1 shows an example of an apparatus or circuit for a mobile device or user equipment, an example of an apparatus or circuit for a network node or NodeB, and an example of a mobile communication system;

FIG. 2 shows a block diagram of an example of a method for a mobile device or user equipment;

FIG. 3 shows a block diagram of an example of a method for a network node or a NodeB;

FIG. 4 shows a message sequence chart in an example;

FIG. 5 shows an example of a mobile communication system;

FIG. 6 shows another example of a mobile communication system;

FIG. 7 shows another example of an apparatus for a mobile device, user equipment, a network node or a NodeB;

FIG. 8 shows example interfaces of baseband circuitry as another example of an apparatus for a mobile device, user equipment, a network node or a NodeB;

FIG. 9 shows a control plane protocol stack in an example;

FIG. 10 shows a user plane protocol stack in an example;

FIG. 11 illustrates core network components in an embodiment;

FIG. 12 illustrates an example of a system supporting network virtualization; and

FIG. 13 illustrates components capable to read machine-readable instructions in an example.

### DETAILED DESCRIPTION

Various examples will now be described more fully with reference to the accompanying drawings in which some examples are illustrated. In the figures, the thicknesses of lines, layers and/or regions may be exaggerated for clarity. Optional components are shown in broken or dotted lines.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong. The terms “example” and “embodiment” are used synonymously.

Mobile communication systems may support dynamic capacity adaptation between uplink (reverse link) and downlink (forward link) transmissions. For example, in a system using Time Division Duplexing (TDD), a first portion of time may be designated to uplink and a second portion of time may be designated for downlink, with an accordingly adapted guard period in between directional switches. A system may adapt the ratio between first portion and the second portion as to shift the capacity of the system towards one or the other direction. Such adaptation may be, for example, carried out by means of assigning discrete time portions to the respective transmission directions, e.g. hyper frames, frames, sub frames, slots, sub slots, symbols etc. In such a system, the number of symbols in a sub frame dedicated to uplink and downlink transmissions may be dynamically adapted to the respective system load.

For example, the 3^{rd} Generation Partnership Project develops New Radio (NR) communication systems, which may support dynamic Time Division Duplexing (TDD). With the introduced dynamics the interference situation in the network may also change dynamically. Examples may enable Cross-Link Interference (CLI) management in dynamic TDD, CLI measurement and reporting should be properly configured. Embodiments herein provide mechanisms for CLI measurement and reporting configurations. Embodiments herein are also related to, for CLI, measurement and reporting timing, the bandwidth over which the measurement and reporting may be conducted, and the transmission (TX) power of the measurement reference signal (RS).

Considering that cross-link interference can have high variations from slot to slot (where the slot-basis is used as an example for a discrete time period, in other examples other time granularities may be used), the measurement and reporting should be able to timely reflect the interference changes. This can be done by having configurable measurement and reporting timing and periodicity. For example, a UE can be configured with long periodicity measurement and reporting when it experiences stable interference environment; a UE can be configured with short periodicity measurement and reporting when it experience fast-changing interference environment; a UE may also be scheduled to do measurement and reporting when there is upcoming traffic.

In the following the dynamic TDD is used as an example. It is to be understood that other duplexing may as well be used dynamically, e.g. dynamic Frequency Division Duplexing, where bandwidth may be dynamically assigned for uplink and downlink. In such a system the interference situation may also become more dynamic and what is explained herein with respect to dynamic TDD, reference signals, and reporting may as well be applied to dynamic FDD or other dynamic duplexing variants.

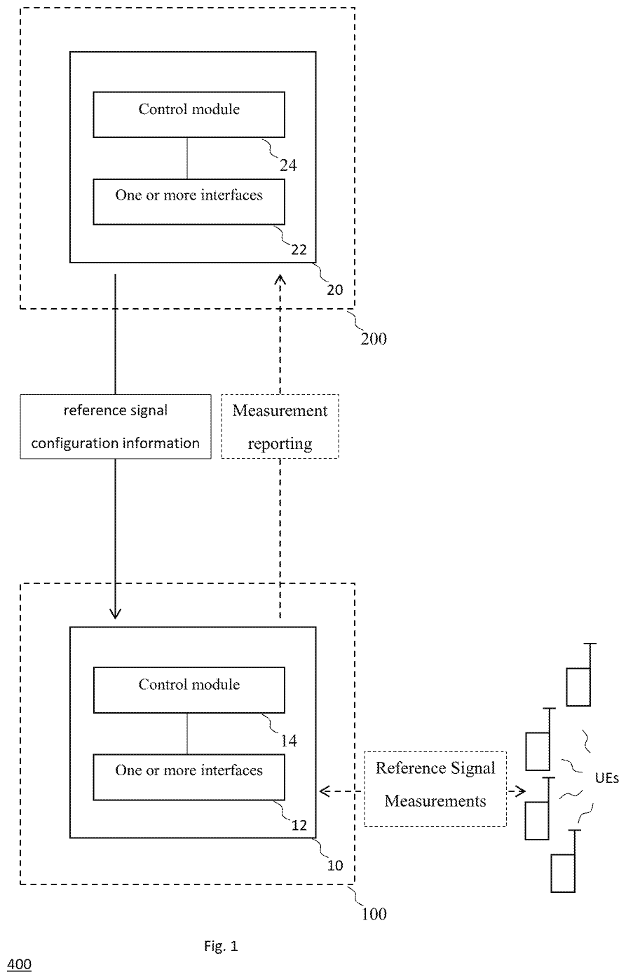

FIG. 1 shows an example of an apparatus or circuit for a mobile device or user equipment, an example of an apparatus or circuit for a network node or NodeB, and an example of a mobile communication system.

FIG. 1 shows an example of an apparatus 10 for a user equipment, UE 100, configured to communicate in a mobile communication system 400. The apparatus 10 may be likewise a circuit, circuitry, a unit, a device, a chip, a semiconductor, or a printed circuit board with electrical components. FIG. 1 also illustrates an example of a mobile device or UE 100 comprising the example of the apparatus or circuit 10. The apparatus 10 comprises one or more interfaces 12, which are configured to communicate within the mobile communication system 400. The apparatus further comprises a control module 14, which is coupled to the one or more interfaces 12. The control module 14 is configured to control the one or more interfaces 12 and to process reference signal configuration information received by the one or more interfaces 12. The reference signal configuration information comprises information on a reference signal radio resource. The reference signal radio resource specifies at least one reference signal from a group of two or more reference signals. The two or more reference signals differ in at least one element of the group of a time-frequency resource, a sequence, and a cyclic shift. The control module 14 is further configured to enable measurements based on the at least one reference signal. Having the choice of two or more reference signals, which differ in their time-frequency-resource, their sequence, or their cyclic shift may offer flexibility to adapt the reference signal to the dynamic duplexing.

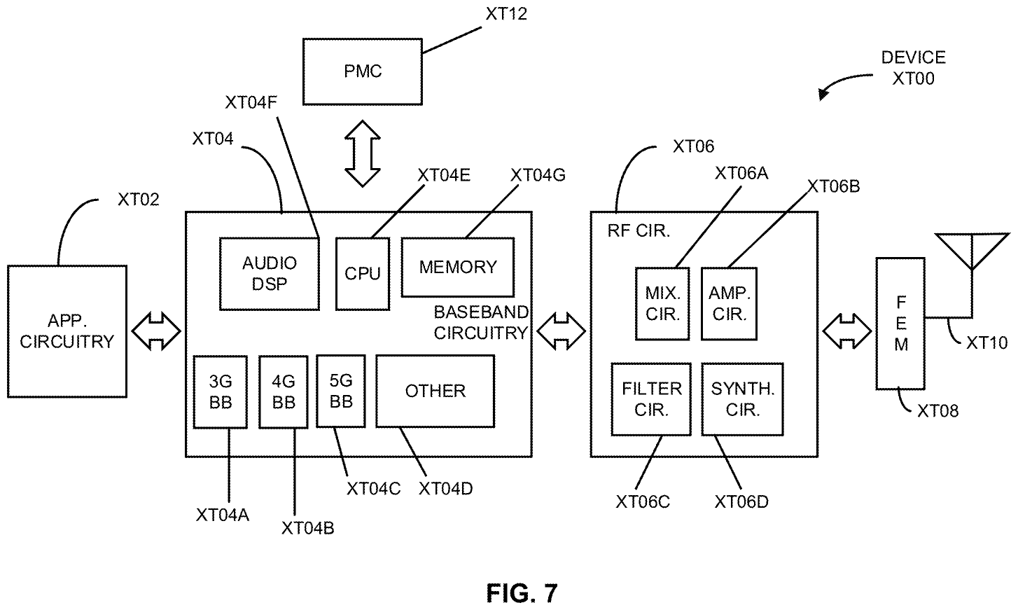

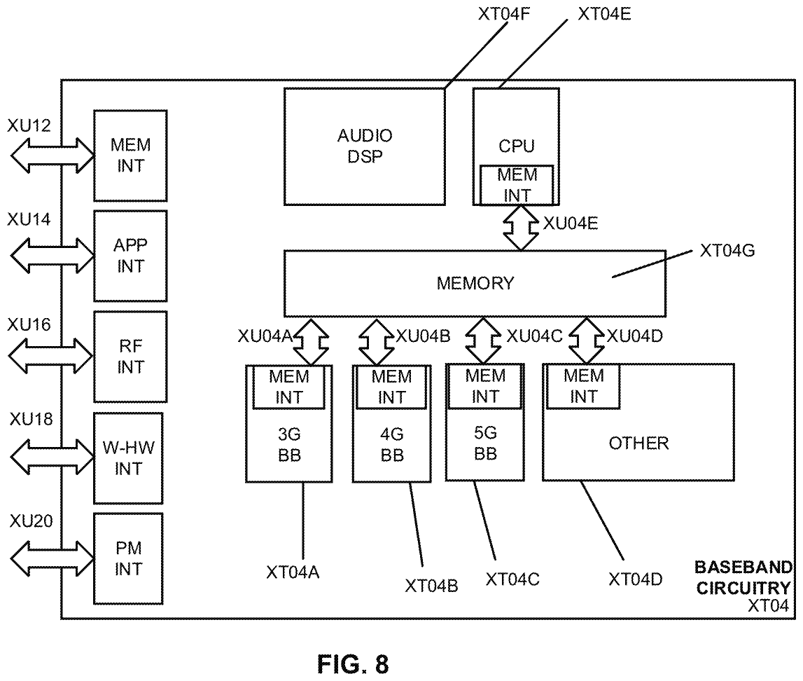

FIG. 1 also illustrates an example of an apparatus 20 for a network node 200 configured to communicate in a mobile communication system 400. The apparatus 20 may be likewise a circuit, circuitry, a unit, a device, a chip, a semiconductor, or a printed circuit board with electrical components. FIG. 1 also illustrates an example of a network node or a NodeB (e.g. eNodeB, gNodeB, or base station) comprising the example of the apparatus or circuit 20. The term NodeB should represent any base station, NodeB, eNodeB, gNode, Access Point, etc. The apparatus 20 comprises one or more interfaces 22 to communicate within the mobile communication system 400. The apparatus 20 further comprises a control module, which is coupled to the one or more interfaces 22. The control module 24 is configured to control the one or more interfaces 22 and to generate reference signal configuration information for a User Equipment, UE 100, or mobile devices. The reference signal configuration information comprises information on a reference signal radio resource. The reference signal resource specifies at least one reference signal from a group of two or more reference signals. The two or more reference signals differ in at least one element of the group of a time-frequency resource, a sequence, and a cyclic shift. The control module 24 is configured to configure measurements based on the at least one reference signal using the one or more interfaces 22. Further details on the implementation and/or functional subdivision of the control modules 14, 24 and interfaces 12, 22 can be found subsequently, particularly in FIGS. 7 and 8.

As indicated by FIG. 1 the reference signal configuration information may be provided from the network node apparatus 20 to the UE apparatus 10. Such information may as well be provided to other UEs. As indicated at the bottom right of FIG. 1 some UEs may hence transmit respective reference signals and some UEs may conduct measurements based on these reference signals as will be laid out in more detail subsequently. Potentially a UE may transmit a reference signal and conduct measurements. Some UE implementations may require utilization of different radio resources with respect to transmission of reference signals and conducting measurements at a UE 100. As further indicated a UE may be configured to measure such reference signals and report on the measurements.

In embodiments or examples the one or more interfaces 12, 22 may correspond to any means for obtaining, receiving, transmitting or providing analog or digital signals or information, e.g. any connector, contact, pin, register, input port, output port, conductor, lane, etc. which allows providing or obtaining a signal or information. Such information may be communicated in terms of analog or digital signals, e.g. by means of messages, digits or blocks represented by digital or binary sequences. An interface may be wireless or wireline and it may be configured to communicate, i.e. transmit or receive signals, information with further internal or external components. The one or more interfaces 12, 22 may comprise or couple to further components to enable according communication in the mobile communication system or environment 400, such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc. The one or more interfaces 12, 22 may be coupled to one or more antennas, which may correspond to any transmit and/or receive antennas, such as horn antennas, dipole antennas, patch antennas, sector antennas etc. The antennas may be arranged in a defined geometrical setting, such as a uniform array, a linear array, a circular array, a triangular array, a uniform field antenna, a field array, combinations thereof, etc. In some examples the one or more interfaces 12, 22 may serve the purpose of transmitting or receiving or both, transmitting and receiving, information, such as information related to a reference signal configuration, a measurement configuration, or reporting of measurement results.

As shown in FIG. 1 the respective one or more interfaces 12, 22 are coupled to the respective control modules 14, 24 at the apparatuses 10, 20. In embodiments or examples the control modules 14, 24 may be implemented using one or more processing units, one or more processing devices, one or more processing units, one or more processing or controlling devices, any means for processing/controlling, any means for determining, any means for calculating, such as a processor, a computer, a controller or a programmable hardware component being operable with accordingly adapted software. In other words, the described function of the control module 14, 24 may as well be implemented in software, which is then executed on one or more programmable hardware components. Such hardware components may comprise a general purpose processor, a controller, a Digital Signal Processor (DSP), a micro-controller, any hardware capable of executing software instructions. In examples accelerated hardware, e.g. an FPGA (Field Programmable Gate Array), may be used to implement the control module 14, 24.

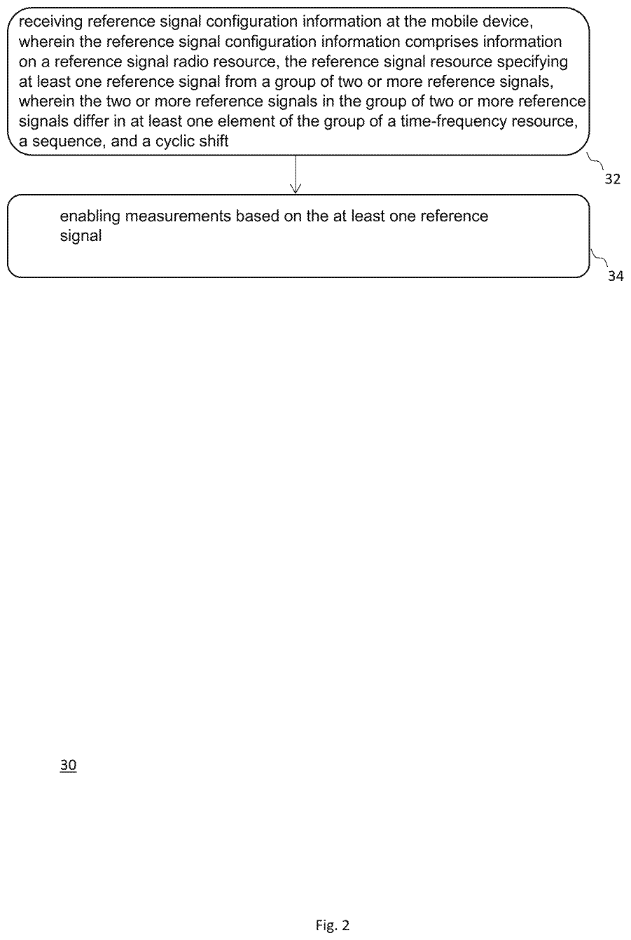

FIG. 2 shows a block diagram of an example of a method 30 for a mobile device or user equipment 100, which is configured to communicate in a mobile communication system 400. The method 30 comprises receiving 32 reference signal configuration information at the mobile device 100. The reference signal configuration information comprises information on a reference signal radio resource. The reference signal resource specifies at least one reference signal from a group of two or more reference signals. The two or more reference signals in the group of two or more reference signals differ in at least one element of the group of a time-frequency resource, a sequence, and a cyclic shift. The method 30 further comprises enabling 34 measurements based on the at least one reference signal.

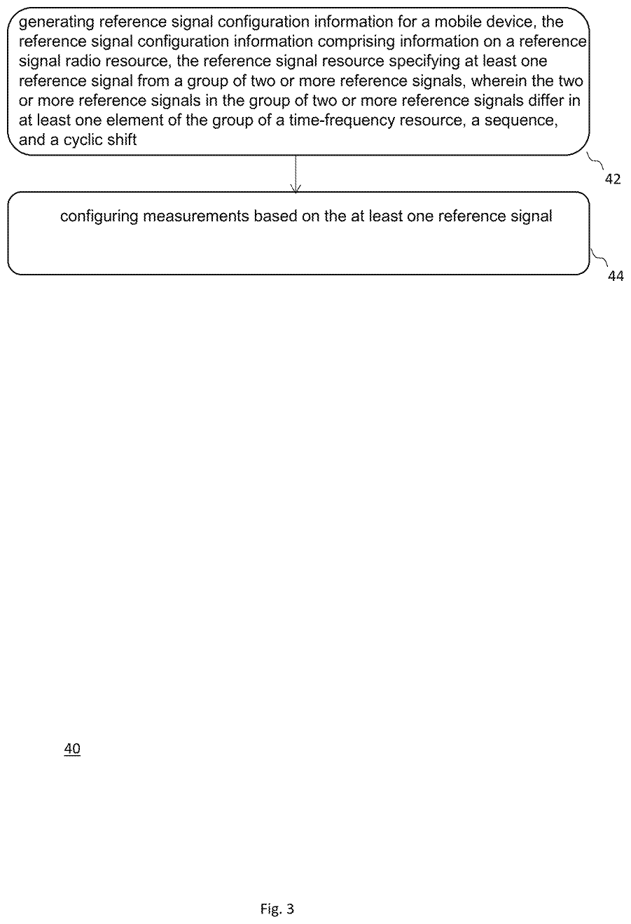

FIG. 3 shows a block diagram of an example of a method 40 for a network node 200 or a NodeB, which is configured to communicate in a mobile communication system 400. The method 40 comprises generating 42 reference signal configuration information for a mobile device 200. The reference signal configuration information comprises information on a reference signal radio resource. The reference signal resource specifies at least one reference signal from a group of two or more reference signals. The two or more reference signals in the group of two or more reference signals differs in at least one element of the group of a time-frequency resource, a sequence, and a cyclic shift. The method 40 further comprises configuring 44 measurements based on the at least one reference signal.

In examples the mobile communication system or network 400 may comprise any Radio Access Technology (RAT). Corresponding transceivers (for example mobile transceivers, user equipment, base stations, relay stations) in the network or system may, for example, operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTSTDD), Time Division-Code Division Multiple Access (TD-CDMA), Time DivisionSynchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code Division Multiple Access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Public Land Mobile Telephony), MTD (Swedish abbreviation for Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handyphone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others.

Examples may also be applied to different Single Carrier or OFDM flavors (CP-OFDM, SC-FDMA, SC-OFDM, filter bank-based multicarrier (FBMC), OFDMA) and in particular 3GPP NR (New Radio) by allocating the OFDM carrier data bit vectors to the corresponding symbol resources.

An access node, network node 200, base station or base station transceiver can be operable to communicate with one or more active mobile transceivers or terminals and a base station transceiver can be located in or adjacent to a coverage area of another base station transceiver, e.g. a macro cell base station transceiver or small cell base station transceiver. Hence, examples may provide a mobile communication system comprising one or more mobile transceivers and one or more base station transceivers, wherein the base station transceivers may establish macro cells or small cells, as e.g. pico-, metro-, or femto cells. A mobile transceiver may correspond to a smartphone, a cell phone, user equipment, a laptop, a notebook, a personal computer, a Personal Digital Assistant (PDA), a Universal Serial Bus (USB)-stick, a car. A mobile transceiver may also be referred to as UE or mobile in line with the 3GPP terminology.

A base station transceiver can be located in the fixed or stationary part of the network or system. A base station transceiver may correspond to a remote radio head, a transmission point, an access point or access node, a macro cell, a small cell, a micro cell, a femto cell, a metro cell. A base station transceiver can be a wireless interface of a wired network, which enables transmission of radio signals to a UE or mobile transceiver. Such a radio signal may comply with radio signals as, for example, standardized by 3GPP or, generally, in line with one or more of the above listed systems. Thus, a base station transceiver may correspond to a NodeB, an eNodeB, a gNodeB, a Base Transceiver Station (BTS), an access point, a remote radio head, a transmission point, which may be further divided into a remote unit and a central unit. Further details on the implementation and functional subdivision or breakdown of a mobile communication system 400 will be provided in the sequel.

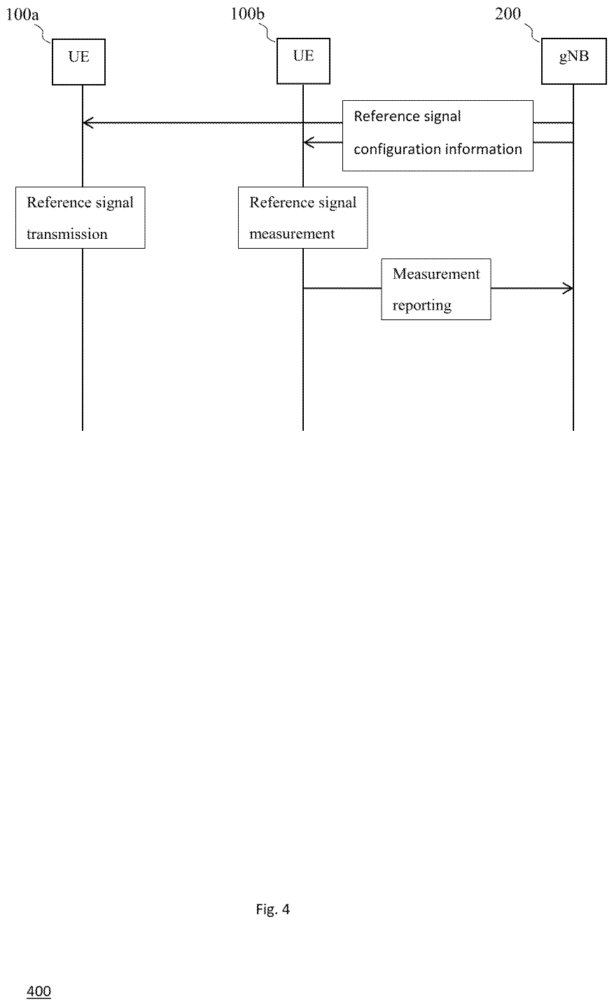

FIG. 4 shows a message sequence chart in an example. FIG. 4 shows a first UE 100a on the left hand side, a second UE 100b in the middle, and a gNodeB (gNB) 200 on the right. As indicated in the message sequence, the gNB 200 may provide reference signal configuration information to the two UEs 100a, 100b. For example, such information may tell UE 100a to transmit a reference signal in a certain time slot. UE 100b may be configured to take an according reference signal measurement, on which UE 100b can report subsequently to the gNB 200.

The third generation partnership project (3GPP) new radio (NR) system may support dynamic time duplex division (TDD) operation on an unpaired spectrum where downlink (DL) and uplink (UL) transmission directions at least for data can be dynamically assigned on a per-slot basis at least in a time division multiplexed (TDM) manner. Generally, examples may specify the enablers for interference management mechanisms for coping with cross-link interference (CLI) in an NR system. UE-to-UE interference measurement and reporting may be configured to be ON or OFF semi-statically and UE-specifically. Moreover, sounding reference signal (SRS)-reference signal received power (RSRP) and received signal strength indicator (RSSI) may be adopted as the measurement metric for cross-link interference (CLI).

In examples for SRS-RSRP based UE-UE CLI measurement, at least SRS may be used for UE-UE CLI measurement, and examples may introduce a mechanism for the network to configure at least a same SRS sequence for one or more UEs transmitting SRS. Examples may support cell-level, UE-group-level, and UE-level interference differentiation. In examples, the reference signal configuration information may comprise information on an identification of a mobile device/UE or identification on a group of mobile devices/UEs.

In examples, a UE may be configured with one or more SRS resource(s) (including time-frequency resource(s), sequence(s), cyclic shift(s), periodicity, etc.) to measure UE-UE CLI interference. Every SRS resource may be explicitly configured, in some examples a UE may conduct SRS blind acquisition, respectively. The maximum of SRS resources may be specified to limit the number of resources to reduce complexity while considering a performance aspect. As such, mechanisms to limit the UE complexity for UE-UE CLI measurement may be also supported. For example, complexity may be reduced by limiting the number of root sequences of SRS for UE-UE CLI measurements that a UE needs to detect within a certain amount of time or by prolonging periodicity. Examples may provide a mechanism to avoid potential DL transmission interfering the SRS for UE-UE CLI measurement, e.g. by rate matching/puncturing the DL transmission around the SRS. Transmission of timing advance of SRS for CLI measurement can be different from the transmission timing advance of its PUSCH (physical uplink shared channel), e.g. D2D channel transmission timing. In some examples, a specific TA mechanism for SRS transmission used for CLI measurement may be enabled.

For an RSSI based UE-UE CLI measurement, a UE may be configured with a set of resource elements to measure UE-UE CLI interference. And the set of resource elements may indicate an SRS or a DM-RS (demodulation reference signal) resource. Examples may introduce configuration signaling and measurement triggering mechanisms to such a system. Moreover, examples may specify an additional mechanism for SRS transmission for RSSI based UE-UE CLI measurements, and/or a mechanism to avoid potential DL transmission in the RSSI measurement resource elements for UE-UE CLI measurement.

Embodiments herein relate to SRS configuration signaling and measurement triggering mechanisms. Specifically, embodiments relate to a flexible UE-group SRS triggering mechanism. By virtue of the various embodiments, the RSSI based coarse CLI measurement as well as RSRP based dominant aggressor CLI can be obtained in a network (NW) controlled manner.

In some embodiments, a UE can be configured by Radio Resource Control (RRC) signaling with one or several SRS resources, each of them is characterized with some of the following parameters including time-frequency resource(s), sequence(s), cyclic shift(s), and periodicity. Using RRC signaling is one option for some embodiments. Other embodiments may as well use other protocols or protocol layers to signal such a configuration.

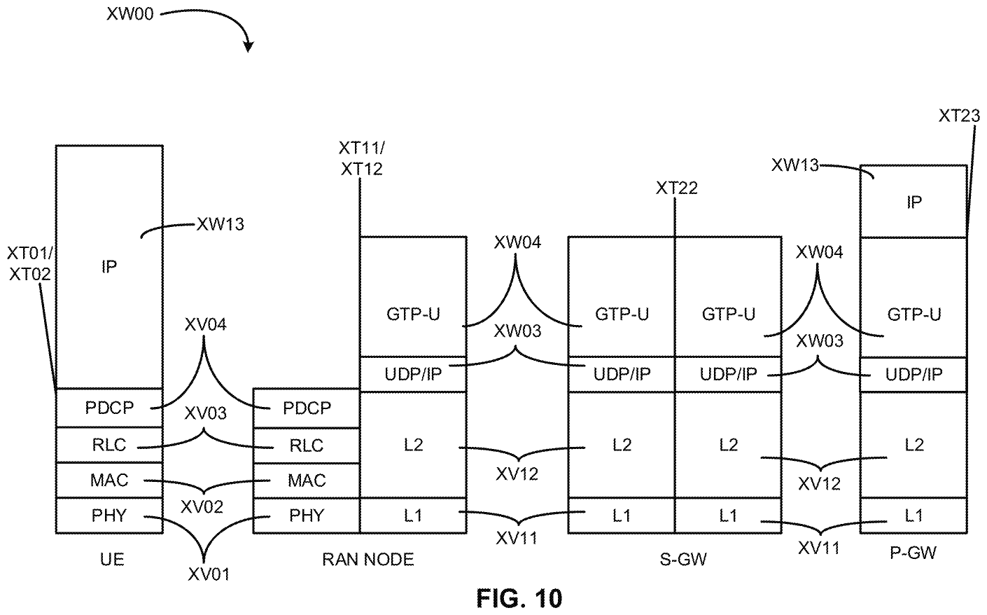

For example, the measurement and reporting periodicity can be configured by L2 (layer 2, Medium Access Control (MAC)) or L1 (layer 1, physical layer (PHY)) signaling. Aperiodic measurement and reporting may be triggered by L1 signaling. Further detail on the protocol stacks and protocol layers that may be sued for such signaling, will be provided subsequently, e.g. FIG. 10 provides an overview. On measurement bandwidth, both wideband and sub band measurements may be supported. With a sub band measurement, a UE may be configured with only conducting measurements in a bandwidth part that the data channel transmission or reception is to be scheduled. The sub band measurement could cause less reporting overhead or could be more accurate. The measurement bandwidth can be configured by L1 signaling.

In some embodiments each configured SRS resource is associated with an SRS index ranging from 1 to SRS_Nmax. The SRS with index 1 is used as the default SRS of the UE. Moreover, each UE may be also configured with one or several SRS group identifiers (IDs). In addition to the UE specific DCI (downlink control indicator), the SRS transmission of a UE may be also triggered by cell-specific or UE-group-specific DCI. From the UE 100 or UE apparatus 10 perspective, the control module 14 may be configured to obtain downlink control information from the mobile communication system 400/network node 200 using the one or more interfaces 12. The downlink control information indicates to transmit the reference signal. From the perspective of the apparatus 20 of the network node or Node B 200 the control module 24 may be configured to provide downlink control information to the one or more interfaces 22 for transmission from the network node 200 of the mobile communication system 400 to the UE 100, 100a, 100b. The downlink control information may indicate to at least one UE to transmit the reference signal.

In further examples the downlink reference signal may address multiple mobile transceivers 100, 100a, 100b. For example, specifically, a cell-specific DCI message may include one or several SRS group IDs, and periodic/aperiodic transmission indicator. Upon the reception of cell-specific SRS triggering DCI, only those UEs with the configured SRS group IDs which are signaled in the DCI message may transmit the configured default SRS. The periodic/aperiodic transmission indicator signals whether the SRS shall be transmitted periodically or not. Alternatively the cyclic redundancy check (CRC) bits of the UE-group-specific DCI message may be scrambled by a SRS scrambling group ID so that only those UEs configured with the scrambling SRS group ID can correctly decode the DCI message requesting the SRS. In such an example, the control module 14 at the UE apparatus 10 may be configured to determine whether a cyclic redundancy check information of the downlink control information addresses the UE 100a, 100b, 100. The control module 24 at the network node apparatus 20 may be further configured to address the UE 100a, 100b, 100 using cyclic redundancy check information of the downlink control information. Furthermore, the control module 14 may be configured to provide information on transmitting the reference signal periodically or aperiodically to the one or more interfaces 12 for transmission. Correspondingly, the control module 24 may be configured to obtain information on transmitting the reference signal periodically or aperiodically using the one or more interfaces 22.

The CLI measurement report may be requested by a UE-specific DCI. At the UE apparatus 10 the control module 14 may be configured to obtain measurement report information, for example as a request to send a measurement report. The measurement report information may comprise an indication on conducting a measurement on a reference signal of another UE using the one or more interfaces 12. The measurement report information may be comprised in downlink control information such as DCI. At the network node apparatus 20 the control module 24 may be configured to generate measurement report information comprising an indication on conducting a measurement on a reference signal of another UE. Correspondingly the measurement report information may be comprised in a DCI, which is then provided from the network node apparatus 20 to the UE apparatus 10 using the one or more interfaces 22.

The measurement report information may comprise information on a measurement metric. For example, the measurement metric may be signaled using DCI. In the 3GPP NR example, DCI may be used to signal the measurement metric. For example, the measurement metric may be an RSSI (Receive Signal Strength Indicator) or an RSRP (Reference Signal Receive Power). Furthermore, the measurement report information provided to the UE apparatus 10 may further comprise information on an identification of the reference signal to be measured. For example, the SRS resource index to be measured may be included and a slot index for PUCCH (Physical Uplink Control Channel) to feedback the first CLI measurement. The measurement report information may further comprise information on whether the report should be periodic or aperiodic. In examples, the reference signal configuration information may comprise information on a periodicity of the reference signal and/or on a periodicity of the respective measurement reports/measurement reporting.

In some examples, the periodic SRS transmission and CLI measurement report may be also dynamically deactivated. The control module 24 at the network node apparatus 20 and the control module 14 at the UE apparatus 10 may then be configured to switch the measurement reports dynamically on and off potentially using respective signaling.

In examples the CLI measurement may be time sensitive as the interference sources in different slots could be different. The dynamics of interference sources from slot to slot may be more prominent in NR considering the various traffic types and the wide bandwidth as compared to earlier systems. Moreover, examples may enable a gNB to make better estimations on the interference environment when it has knowledge on the time slot that a measurement is conducted. Examples may enable to define a reference resource for a CLI measurement report in a slot #n, i.e., for a UE that reports CLI measurement in slot #n, the CLI reference resource may be defined by a single slot #(n-n_{ref}). The control module 24, 14 may be configured to use respective configurations or indexing. For example, the reference signal configuration information may comprise an index indexing preconfigured reference signal configurations and/or information on the above slot configuration for measuring and reporting.

In some examples, an RSSI measurement may need to be conducted over fixed symbol(s) in a slot. This may help in reducing or minimizing the UE power consumption in doing measurement and it may allow the RSSI measurement to reflect not only on-going interference but also upcoming interference. For RSSI measurements for the upcoming interference, the upcoming interfering sources would transmit RSs in the symbols over which the RSSI measurement is conducted. The RS transmission may be in wideband or in a subband. The measurement report information may further comprise information on a bandwidth, which should be measured. For example in subband transmission, the bandwidth part over which the measurement RS is transmitted may be the same as the bandwidth part over which a data channel is going to be scheduled. In some examples, the RS transmission power may be related to data transmission power. In order to perform cross-link interference estimation, the same transmission power may be applied for RS and the respective PUSCH or PDSCH (Physical Uplink Shared Channel, Physical Downlink Shared Channel).

In some examples, the BWP (BandWidth Part) and/or CORESET (Control Resource Set) may be deactivated whenever it is not in active use. This may save power consumption of UEs. Some examples may use multiple SRS resource configurations. A UE may be configured by RRC (Radio Resource Control) signaling (or other layer signaling) with one or several SRS resources, each of which may be characterized with some of the following parameters including
time-frequency resource(s),
sequence(s),
cyclic shift(s),
periodicity etc.

The reference signal configuration information may be signaled by means of radio resource control signaling of the mobile communication system. Other protocols or protocol layers such as layer 1 or layer 2 may be used alternatively or additionally. In general, the lower layer signaling may enable quicker reaction. In the sequel the protocol stack in a 5G/NR system will be described in more detail.

Each configured SRS resource may be associated with an SRS resource index ranging from 1 to SRS_Nmax in some examples. The SRS with resource index 1 may be defined as the default SRS resource of the UE 100. The maximum number of SRS resources which may be configured to the UE 100 may be a parameter associated with UE capability. A same default SRS resource may be transmitted by a group of UEs to enable RSSI based coarse CLI measurements in some examples. Other configured SRS resources may be scheduled by the network (NW)/network node 200 for a smaller set of selected UEs, and thereby RSRP based CLI measurement may help the NW to identify a dominant group of aggressor UEs (interferers).

Some examples may use DCI based dynamic SRS request signaling. A UE 100 may be also configured with one or several SRS request ID(s). The configured SRS request ID may be used by the NW to request a UE 100 to transmit a SRS resource. The following two methods may be employed by the NW to send a SRS transmission request to UEs. In a first method explicit multiple SRS request signaling with common DCI may be used. In this method, a cell-specific or UE-group-specific DCI message may be addressed to all UEs or a group of UEs in the cell, Such a message may contain one or several SRS request IDs as well as a periodic/aperiodic transmission indicator. For example, the following format can be used:

Cell/UE-group-specific SRS request DCI:={SRS request ID #1, SRS request ID #2, . . . , SRS request ID #N, Periodic/Aperiodic transmission indicator, start time slot}

Upon receiving the above DCI message, all the UEs with any of configured SRS request IDs being signaled in the DCI message may/should transmit respective default SRS sources starting from the signaled time slot either periodically or in one shot as per the transmission indicator. If all the UEs receiving the SRS transmission request are configured with the same default SRS resource, then the same SRS shall/may be transmitted by all the UEs, this may be useful for the victim UEs to measure a RSSI based coarse CLI without the need to identify a particular group of aggressor UEs. In another scenario, the NW may divide the UEs in a cell in several non-overlapping groups with different SRS request IDs as well as different default SRS resources. By virtue of the above common DCI based SRS request message, different groups of UEs shall/may transmit different SRS resources. A configured RSRP measurement of different SRS resources by the victim UEs may distinguish different levels of CLI from different groups of aggressor UEs. This may help the NW to perform more intelligent interference management.

As second option in examples implicit SRS request signaling with common DCI may be used. In this method, the CRC (Cyclic Redundancy Check) bits of a common DCI message for SRS request signaling shall be scrambled by a particular SRS request ID. Only those UEs configured with the used SRS request ID can correctly decode the DCI message requesting the SRS. As such, each SRS request DCI can only schedule SRS transmission from single group of UEs.

Further examples may use DCI based dynamic CLI measurement report request signaling. Using this option the NW or network node apparatus 20 may/shall request a selected group of victim UEs to measure and report a certain CLI metric based on the requested SRS transmission scheduled as lined out above. The following method may be applied to request the CLI measurement report. In this example method UE specific CLI measurement report request signaling is used. A UE-specific DCI may/can request a UE 100 to feedback the CLI measurement result in terms of a signaled performance metric, e.g. RSSI or RSRP, on a certain configured SRS resource. The measurement report may be periodic or aperiodic. The DCI signaling also schedules the exact time slot or symbols for the CLI measurement report transmission.

By virtue of the above examples with the three elements of multiple SRS resource configuration, DCI based dynamic SRS request signaling, and DCI based dynamic measurement report request signaling, the NW may configure periodic/aperiodic SRS transmission and CLI measurement reporting. Specifically the periodic SRS transmission and CLI feedback may be dynamically activated and deactivated.

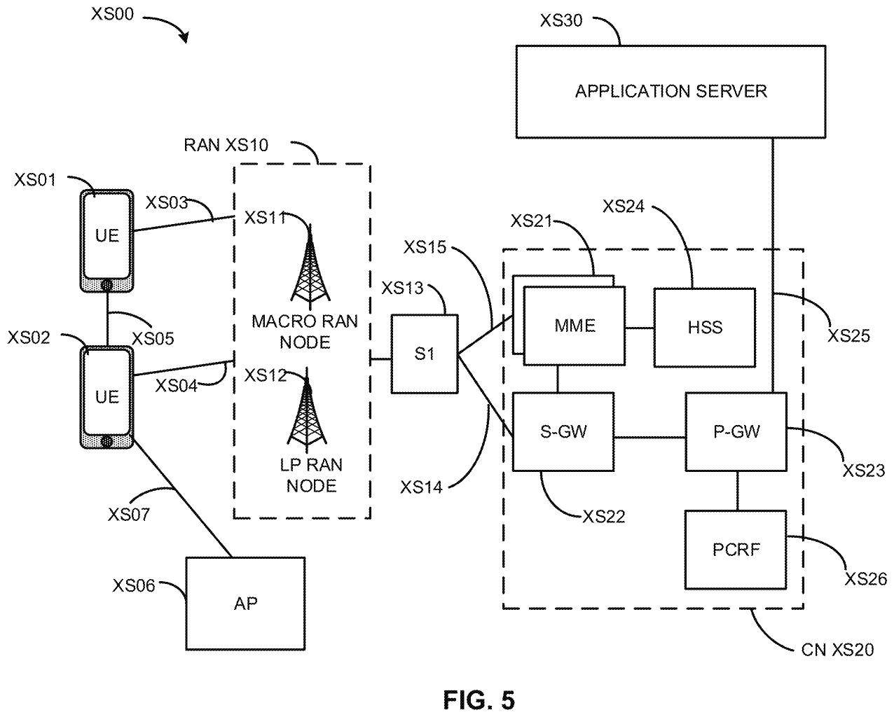

FIG. 5 shows another example of a mobile communication system 400. FIG. 5 illustrates an architecture of a system XS00 of a network in accordance with some embodiments. The system XS00 is shown to include a user equipment (UE) XS01 and a UE XS02. The UEs XS01 and XS02 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs XS01 and XS02 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs XS01 and XS02 may be configured to connect, e.g., communicatively couple, with a radio access network (RAN) XS10—the RAN XS10 may be, for example, an Evolved Universal Mobile Telecommunications System (UMTS) Terrestrial Radio Access Network (E-UTRAN), a NextGen RAN (NG RAN), or some other type of RAN. The UEs XS01 and XS02 utilize connections XS03 and XS04, respectively, each of which comprises a physical communications interface or layer (discussed in further detail below); in this example, the connections XS03 and XS04 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs XS01 and XS02 may further directly exchange communication data via a ProSe interface XS05. The ProSe interface XS05 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE XS02 is shown to be configured to access an access point (AP) XS06 via connection XS07. The connection XS07 can comprise a local wireless connection, such as a connection consistent with any IEEE 802.11 protocol, wherein the AP XS06 would comprise a wireless fidelity (WiFi®) router. In this example, the AP XS06 is shown to be connected to the Internet without connecting to the core network of the wireless system (described in further detail below).

The RAN XS10 can include one or more access nodes that enable the connections XS03 and XS04. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN XS10 may include one or more RAN nodes for providing macrocells, e.g., macro RAN node XS11, and one or more RAN nodes for providing femtocells or picocells (e.g., cells having smaller coverage areas, smaller user capacity, or higher bandwidth compared to macrocells), e.g., low power (LP) RAN node XS12.

Any of the RAN nodes XS11 and XS12 can terminate the air interface protocol and can be the first point of contact for the UEs XS01 and XS02. In some embodiments, any of the RAN nodes XS11 and XS12 can fulfill various logical functions for the RAN XS10 including, but not limited to, radio network controller (RNC) functions such as radio bearer management, uplink and downlink dynamic radio resource management and data packet scheduling, and mobility management.

In accordance with some embodiments, the UEs XS01 and XS02 can be configured to communicate using Orthogonal Frequency-Division Multiplexing (OFDM) communication signals with each other or with any of the RAN nodes XS11 and XS12 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes XS11 and XS12 to the UEs XS01 and XS02, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs XS01 and XS02. The physical downlink control channel (PDCCH) may carry information about the transport format and resource allocations related to the PDSCH channel, among other things. It may also inform the UEs XS01 and XS02 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes XS11 and XS12 based on channel quality information fed back from any of the UEs XS01 and XS02. The downlink resource assignment information may be sent on the PDCCH used for (e.g., assigned to) each of the UEs XS01 and XS02.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN XS10 is shown to be communicatively coupled to a core network (CN) XS20 via an S1 interface XS13. In embodiments, the CN XS20 may be an evolved packet core (EPC) network, a NextGen Packet Core (NPC) network, or some other type of CN. In this embodiment the S1 interface XS13 is split into two parts: the S1-U interface XS14, which carries traffic data between the RAN nodes XS11 and XS12 and the serving gateway (S-GW) XS22, and the S1-mobility management entity (MME) interface XS15, which is a signaling interface between the RAN nodes XS11 and XS12 and MMEs XS21.

In this embodiment, the CN XS20 comprises the MMEs XS21, the S-GW XS22, the Packet Data Network (PDN) Gateway (P-GW) XS23, and a home subscriber server (HSS) XS24. The MMEs XS21 may be similar in function to the control plane of legacy Serving General Packet Radio Service (GPRS) Support Nodes (SGSN). The MMEs XS21 may manage mobility aspects in access such as gateway selection and tracking area list management. The HSS XS24 may comprise a database for network users, including subscription-related information to support the network entities' handling of communication sessions. The CN XS20 may comprise one or several HSSs XS24, depending on the number of mobile subscribers, on the capacity of the equipment, on the organization of the network, etc. For example, the HSS XS24 can provide support for routing/roaming, authentication, authorization, naming/addressing resolution, location dependencies, etc.

The S-GW XS22 may terminate the S1 interface XS13 towards the RAN XS10, and routes data packets between the RAN XS10 and the CN XS20. In addition, the S-GW XS22 may be a local mobility anchor point for inter-RAN node handovers and also may provide an anchor for inter-3GPP mobility. Other responsibilities may include lawful intercept, charging, and some policy enforcement.

The P-GW XS23 may terminate an SGi interface toward a PDN. The P-GW XS23 may route data packets between the EPC network XS23 and external networks such as a network including the application server XS30 (alternatively referred to as application function (AF)) via an Internet Protocol (IP) interface XS25. Generally, the application server XS30 may be an element offering applications that use IP bearer resources with the core network (e.g., UMTS Packet Services (PS) domain, LTE PS data services, etc.). In this embodiment, the P-GW XS23 is shown to be communicatively coupled to an application server XS30 via an IP communications interface XS25. The application server XS30 can also be configured to support one or more communication services (e.g., Voice-over-Internet Protocol (VoIP) sessions, PTT sessions, group communication sessions, social networking services, etc.) for the UEs XS01 and XS02 via the CN XS20.

The P-GW XS23 may further be a node for policy enforcement and charging data collection. Policy and Charging Enforcement Function (PCRF) XS26 is the policy and charging control element of the CN XS20. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF XS26 may be communicatively coupled to the application server XS30 via the P-GW XS23. The application server XS30 may signal the PCRF XS26 to indicate a new service flow and select the appropriate Quality of Service (QoS) and charging parameters. The PCRF XS26 may provision this rule into a Policy and Charging Enforcement Function (PCEF) (not shown) with the appropriate traffic flow template (TFT) and QoS class of identifier (QCI), which commences the QoS and charging as specified by the application server XS30.

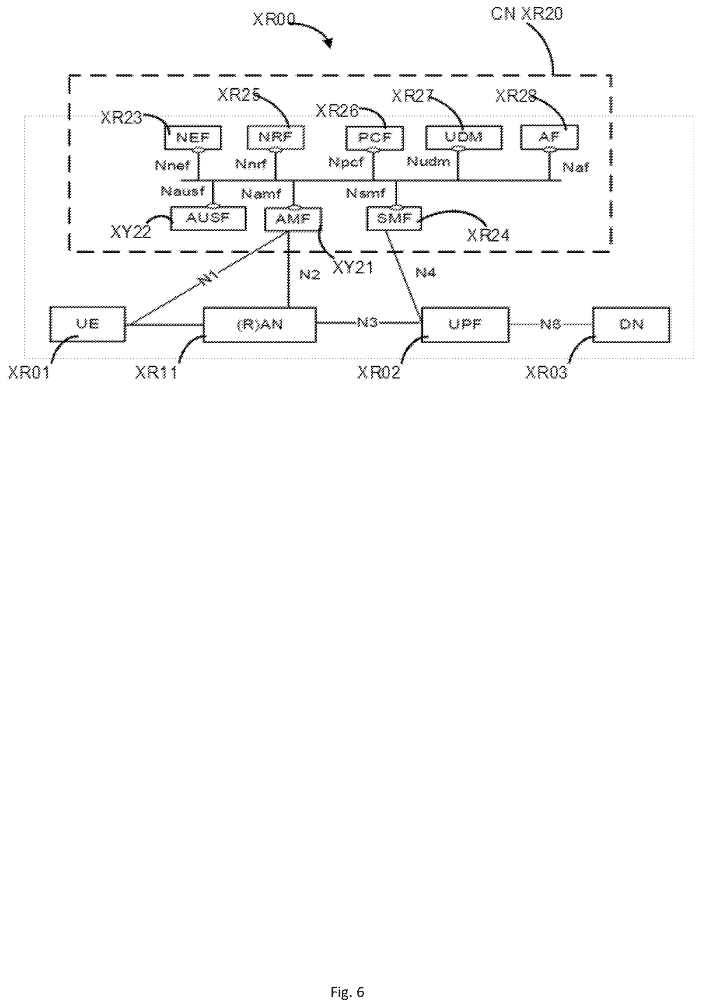

FIG. 6 shows another example of a mobile communication system. FIG. 6 illustrates an architecture of a system XR00 of a network in accordance with some embodiments. The system XR00 is shown to include a UE XR01, which may be the same or similar to the UEs, e.g. XS01 and XS02, discussed previously; a RAN node XR11, which may be the same or similar to RAN nodes, e.g. XS11 and XS12, discussed previously; a User Plane Function (UPF) XR02; a Data network (DN) XR03, which may be, for example, operator services, Internet access or 3rd party services; and a 5G Core Network (5GC or CN) XR20.

The CN XR20 may include an Authentication Server Function (AUSF) XR22; a Core Access and Mobility Management Function (AMF) XR21; a Session Management Function (SMF) XR24; a Network Exposure Function (NEF) XR23; a Policy Control function (PCF) XR26; a Network Function (NF) Repository Function (NRF) XR25; a Unified Data Management (UDM) XR27; and an Application Function (AF) XR28. The CN XR20 may also include other elements that are not shown, such as a Structured Data Storage network function (SDSF), an Unstructured Data Storage network function (UDSF), and the like.

The UPF XR02 may act as an anchor point for intra-RAT and inter-RAT mobility, an external PDU session point of interconnect to DN XR03, and a branching point to support multi-homed PDU session. The UPF XR02 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (e.g., SDF to QoS flow mapping), transport level packet marking in the uplink and downlink, and downlink packet buffering and downlink data notification triggering. UPF XR02 may include an uplink classifier to support routing traffic flows to a data network. The DN XR03 may represent various network operator services, Internet access, or third party services. NY XR03 may include, or be similar to application server XS30 discussed previously.

The AUSF XR22 may store data for authentication of UE XR01 and handle authentication related functionality. It facilitates a common authentication framework for various access types.

The AMF XR21 may be responsible for registration management (e.g., for registering UE XR01, etc.), connection management, reachability management, mobility management, and lawful interception of AMF-related events, and access authentication and authorization. AMF XR21 may provide transport for SM messages between and SMF XR24, and act as a transparent proxy for routing SM messages. AMF XR21 may also provide transport for short message service (SMS) messages between UE XR01 and an SMS function (SMSF) (not shown by FIG. 6). AMF XR21 may act as Security Anchor Function (SEA), which may include interaction with the AUSF XR22 and the UE XR01, receipt of an intermediate key that was established as a result of the UE XR01 authentication process. Where USIM based authentication is used, the AMF XR21 may retrieve the security material from the AUSF XR22. AMF XR21 may also include a Security Context Management (SCM) function, which receives a key from the SEA that it uses to derive access-network specific keys. Furthermore, AMF XR21 may be a termination point of RAN CP interface (N2 reference point), a termination point of NAS (N1) signalling, and perform NAS ciphering and integrity protection.

AMF XR21 may also support NAS signalling with a UE XR01 over an N3 interworking-function (IWF) interface. The N3IWF may be used to provide access to untrusted entities. N33IWF may be a termination point for the N2 and N3 interfaces for control plane and user plane, respectively, and as such, may handle N2 signalling from SMF and AMF for PDU sessions and QoS, encapsulate/de-encapsulate packets for IPSec and N3 tunneling, mark N3 user-plane packets in the uplink, and enforce QoS corresponding to N3 packet marking taking into account QoS requirements associated to such marking received over N2. N3IWF may also relay uplink and downlink control-plane NAS (N1) signalling between the UE XR01 and AMF XR21, and relay uplink and downlink user-plane packets between the UE XR01 and UPF XR02. The N3IWF also provides mechanisms for IPsec tunnel establishment with the UE XR01.

The SMF XR24 may be responsible for session management (e.g., session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. The SMF XR24 may include the following roaming functionality: handle local enforcement to apply QoS SLAB (VPLMN); charging data collection and charging interface (VPLMN); lawful intercept (in VPLMN for SM events and interface to LI System); support for interaction with external DN for transport of signalling for PDU session authorization/authentication by external DN.

The NEF XR23 may provide means for securely exposing the services and capabilities provided by 3GPP network functions for third party, internal exposure/re-exposure, Application Functions (e.g., AF XR28), edge computing or fog computing systems, etc. In such embodiments, the NEF XR23 may authenticate, authorize, and/or throttle the AFs. NEF XR23 may also translate information exchanged with the AF XR28 and information exchanged with internal network functions. For example, the NEF XR23 may translate between an AF-Service-Identifier and an internal 5GC information. NEF XR23 may also receive information from other network functions (NFs) based on exposed capabilities of other network functions. This information may be stored at the NEF XR23 as structured data, or at a data storage NF using a standardized interfaces. The stored information can then be re-exposed by the NEF XR23 to other NFs and AFs, and/or used for other purposes such as analytics. The NRF XR25 may support service discovery functions, receive NF Discovery Requests from NF instances, and provide the information of the discovered NF instances to the NF instances. NRF XR25 also maintains information of available NF instances and their supported services.

The PCF XR26 may provide policy rules to control plane function(s) to enforce them, and may also support unified policy framework to govern network behaviour. The PCF XR26 may also implement a front end (FE) to access subscription information relevant for policy decisions in a UDR of UDM XR27.

The UDM XR27 may handle subscription-related information to support the network entities' handling of communication sessions, and may store subscription data of UE XR01. The UDM XR27 may include two parts, an application FE and a User Data Repository (UDR). The UDM may include a UDM FE, which is in charge of processing of credentials, location management, subscription management and so on. Several different front ends may serve the same user in different transactions. The UDM-FE accesses subscription information stored in the UDR and performs authentication credential processing; user identification handling; access authorization; registration/mobility management; and subscription management. The UDR may interact with PCF XR26. UDM XR27 may also support SMS management, wherein an SMS-FE implements the similar application logic as discussed previously.

The AF XR28 may provide application influence on traffic routing, access to the Network Capability Exposure (NCE), and interact with the policy framework for policy control. The NCE may be a mechanism that allows the 5GC and AF XR28 to provide information to each other via NEF XR23, which may be used for edge computing implementations. In such implementations, the network operator and third party services may be hosted close to the UE XR01 access point of attachment to achieve an efficient service delivery through the reduced end-to-end latency and load on the transport network. For edge computing implementations, the 5GC may select a UPF XR02 close to the UE XR01 and execute traffic steering from the UPF XR02 to DN XR03 via the N6 interface. This may be based on the UE subscription data, UE location, and information provided by the AF XR28. In this way, the AF XR28 may influence UPF (re)selection and traffic routing. Based on operator deployment, when AF XR28 is considered to be a trusted entity, the network operator may permit AF XR28 to interact directly with relevant NFs.

As discussed previously, the CN XR20 may include an SMSF, which may be responsible for SMS subscription checking and verification, and relaying SM messages to/from the UE XR01 to/from other entities, such as an SMS-GMSC/IWMSC/SMS-router. The SMS may also interact with AMF XR21 and UDM XR27 for notification procedure that the UE XR01 is available for SMS transfer (e.g., set a UE not reachable flag, and notifying UDM XR27 when UE XR01 is available for SMS).

The system XR00 may include the following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

The system XR00 may include the following reference points: N1: Reference point between the UE and the AMF; N2: Reference point between the (R)AN and the AMF; N3: Reference point between the (R)AN and the UPF; N4: Reference point between the SMF and the UPF; and N6: Reference point between the UPF and a Data Network. There may be many more reference points and/or service-based interfaces between the NF services in the NFs, however, these interfaces and reference points have been omitted for clarity. For example, an N5 reference point may be between the PCF and the AF; an N7 reference point may be between the PCF and the SMF; an N11 reference point between the AMF and SMF; etc. In some embodiments, the CN XR20 may include an Nx interface, which is an inter-CN interface between the MME (e.g., MME XS21) and the AMF XR21 in order to enable interworking between CN XR20 and CN XS20.

Although not shown by FIG. 6, system XR00 may include multiple RAN nodes XR11 wherein an Xn interface is defined between two or more RAN nodes XR11 (e.g., gNBs and the like) that connecting to 5GC XR20, between a RAN node XR11 (e.g., gNB) connecting to 5GC XR20 and an eNB (e.g., a RAN node XS11 of FIG. 5), and/or between two eNBs connecting to 5GC XR20.

In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE XR01 in a connected mode (e.g., CM-CONNECTED) including functionality to manage the UE mobility for connected mode between one or more RAN nodes XR11. The mobility support may include context transfer from an old (source) serving RAN node XR11 to new (target) serving RAN node XR11; and control of user plane tunnels between old (source) serving RAN node XR11 to new (target) serving RAN node XR11.

A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on an SCTP layer. The SCTP layer may be on top of an IP layer. The SCTP layer provides the guaranteed delivery of application layer messages. In the transport IP layer point-to-point transmission is used to deliver the signaling PDUs. In other implementations, the Xn-U protocol stack and/or the Xn-C protocol stack may be same or similar to the user plane and/or control plane protocol stack(s) shown and described herein.

FIG. 7 shows another example of an apparatus for a mobile device, user equipment, a network node or a NodeB. FIG. 7 illustrates example components of a device XT00 in accordance with some embodiments. In some embodiments, the device XT00 may include application circuitry XT02, baseband circuitry XT04, Radio Frequency (RF) circuitry XT06, front-end module (FEM) circuitry XT08, one or more antennas XT10, and power management circuitry (PMC) XT12 coupled together at least as shown. The components of the illustrated device XT00 may be included in a UE or a RAN node. In some embodiments, the device XT00 may include less elements (e.g., a RAN node may not utilize application circuitry XT02, and instead include a processor/controller to process IP data received from an EPC). In some embodiments, the device XT00 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry XT02 may include one or more application processors. For example, the application circuitry XT02 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device XT00. In some embodiments, processors of application circuitry XT02 may process IP data packets received from an EPC.

The baseband circuitry XT04 may include circuitry such as, but not limited to, one or more single-core or multi-core processors. The baseband circuitry XT04 may include one or more baseband processors or control logic to process baseband signals received from a receive signal path of the RF circuitry XT06 and to generate baseband signals for a transmit signal path of the RF circuitry XT06. Baseband processing circuitry XT04 may interface with the application circuitry XT02 for generation and processing of the baseband signals and for controlling operations of the RF circuitry XT06. For example, in some embodiments, the baseband circuitry XT04 may include a third generation (3G) baseband processor XT04A, a fourth generation (4G) baseband processor XT04B, a fifth generation (5G) baseband processor XT04C, or other baseband processor(s) XT04D for other existing generations, generations in development or to be developed in the future (e.g., second generation (2G), sixth generation (6G), etc.). The baseband circuitry XT04 (e.g., one or more of baseband processors XT04A-D) may handle various radio control functions that enable communication with one or more radio networks via the RF circuitry XT06.

In other embodiments, some or all of the functionality of baseband processors XT04A-D may be included in modules stored in the memory XT04G and executed via a Central Processing Unit (CPU) XT04E. The radio control functions may include, but are not limited to, signal modulation/demodulation, encoding/decoding, radio frequency shifting, etc. In some embodiments, modulation/demodulation circuitry of the baseband circuitry XT04 may include Fast-Fourier Transform (FFT), precoding, or constellation mapping/demapping functionality. In some embodiments, encoding/decoding circuitry of the baseband circuitry XT04 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry XT04 may include one or more audio digital signal processor(s) (DSP) XT04F. The audio DSP(s) XT04F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry XT04 and the application circuitry XT02 may be implemented together such as, for example, on a system on a chip (SOC).

In some embodiments, the baseband circuitry XT04 may provide for communication compatible with one or more radio technologies. For example, in some embodiments, the baseband circuitry XT04 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry XT04 is configured to support radio communications of more than one wireless protocol may be referred to as multi-mode baseband circuitry.

RF circuitry XT06 may enable communication with wireless networks using modulated electromagnetic radiation through a non-solid medium. In various embodiments, the RF circuitry XT06 may include switches, filters, amplifiers, etc. to facilitate the communication with the wireless network. RF circuitry XT06 may include a receive signal path which may include circuitry to down-convert RF signals received from the FEM circuitry XT08 and provide baseband signals to the baseband circuitry XT04. RF circuitry XT06 may also include a transmit signal path which may include circuitry to up-convert baseband signals provided by the baseband circuitry XT04 and provide RF output signals to the FEM circuitry XT08 for transmission.

In some embodiments, the receive signal path of the RF circuitry XT06 may include mixer circuitry XT06a, amplifier circuitry XT06b and filter circuitry XT06c. In some embodiments, the transmit signal path of the RF circuitry XT06 may include filter circuitry XT06c and mixer circuitry XT06a. RF circuitry XT06 may also include synthesizer circuitry XT06d for synthesizing a frequency for use by the mixer circuitry XT06a of the receive signal path and the transmit signal path. In some embodiments, the mixer circuitry XT06a of the receive signal path may be configured to down-convert RF signals received from the FEM circuitry XT08 based on the synthesized frequency provided by synthesizer circuitry XT06d. The amplifier circuitry XT06b may be configured to amplify the down-converted signals and the filter circuitry XT06c may be a low-pass filter (LPF) or band-pass filter (BPF) configured to remove unwanted signals from the down-converted signals to generate output baseband signals. Output baseband signals may be provided to the baseband circuitry XT04 for further processing. In some embodiments, the output baseband signals may be zero-frequency baseband signals, although this is not a requirement. In some embodiments, mixer circuitry XT06a of the receive signal path may comprise passive mixers, although the scope of the embodiments is not limited in this respect.

In some embodiments, the mixer circuitry XT06a of the transmit signal path may be configured to up-convert input baseband signals based on the synthesized frequency provided by the synthesizer circuitry XT06d to generate RF output signals for the FEM circuitry XT08. The baseband signals may be provided by the baseband circuitry XT04 and may be filtered by filter circuitry XT06c.

In some embodiments, the mixer circuitry XT06a of the receive signal path and the mixer circuitry XT06a of the transmit signal path may include two or more mixers and may be arranged for quadrature downconversion and upconversion, respectively. In some embodiments, the mixer circuitry XT06a of the receive signal path and the mixer circuitry XT06a of the transmit signal path may include two or more mixers and may be arranged for image rejection (e.g., Hartley image rejection). In some embodiments, the mixer circuitry XT06a of the receive signal path and the mixer circuitry XT06a may be arranged for direct downconversion and direct upconversion, respectively. In some embodiments, the mixer circuitry XT06a of the receive signal path and the mixer circuitry XT06a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry XT06 may include analog-to-digital converter (ADC) and digital-to-analog converter (DAC) circuitry and the baseband circuitry XT04 may include a digital baseband interface to communicate with the RF circuitry XT06.

In some dual-mode embodiments, a separate radio IC circuitry may be provided for processing signals for each spectrum, although the scope of the embodiments is not limited in this respect.

In some embodiments, the synthesizer circuitry XT06d may be a fractional-N synthesizer or a fractional N/N+1 synthesizer, although the scope of the embodiments is not limited in this respect as other types of frequency synthesizers may be suitable. For example, synthesizer circuitry XT06d may be a delta-sigma synthesizer, a frequency multiplier, or a synthesizer comprising a phase-locked loop with a frequency divider.

The synthesizer circuitry XT06d may be configured to synthesize an output frequency for use by the mixer circuitry XT06a of the RF circuitry XT06 based on a frequency input and a divider control input. In some embodiments, the synthesizer circuitry XT06d may be a fractional N/N+1 synthesizer.

In some embodiments, frequency input may be provided by a voltage controlled oscillator (VCO), although that is not a requirement. Divider control input may be provided by either the baseband circuitry XT04 or the applications processor XT02 depending on the desired output frequency. In some embodiments, a divider control input (e.g., N) may be determined from a look-up table based on a channel indicated by the applications processor XT02.

Synthesizer circuitry XT06d of the RF circuitry XT06 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry XT06d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry XT06 may include an IQ/polar converter.

FEM circuitry XT08 may include a receive signal path which may include circuitry configured to operate on RF signals received from one or more antennas XT10, amplify the received signals and provide the amplified versions of the received signals to the RF circuitry XT06 for further processing. FEM circuitry XT08 may also include a transmit signal path which may include circuitry configured to amplify signals for transmission provided by the RF circuitry XT06 for transmission by one or more of the one or more antennas XT10. In various embodiments, the amplification through the transmit or receive signal paths may be done solely in the RF circuitry XT06, solely in the FEM XT08, or in both the RF circuitry XT06 and the FEM XT08.

In some embodiments, the FEM circuitry XT08 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry XT06). The transmit signal path of the FEM circuitry XT08 may include a power amplifier (PA) to amplify input RF signals (e.g., provided by RF circuitry XT06), and one or more filters to generate RF signals for subsequent transmission (e.g., by one or more of the one or more antennas XT10).

In some embodiments, the PMC XT12 may manage power provided to the baseband circuitry XT04. In particular, the PMC XT12 may control power-source selection, voltage scaling, battery charging, or DC-to-DC conversion. The PMC XT12 may often be included when the device XT00 is capable of being powered by a battery, for example, when the device is included in a UE. The PMC XT12 may increase the power conversion efficiency while providing desirable implementation size and heat dissipation characteristics.

While FIG. 7 shows the PMC XT12 coupled only with the baseband circuitry XT04, however, in other embodiments, the PMC XT 12 may be additionally or alternatively coupled with, and perform similar power management operations for, other components such as, but not limited to, application circuitry XT02, RF circuitry XT06, or FEM XT08.

In some embodiments, the PMC XT12 may control, or otherwise be part of, various power saving mechanisms of the device XT00. For example, if the device XT00 is in an RRC Connected state, where it is still connected to the RAN node as it expects to receive traffic shortly, then it may enter a state known as Discontinuous Reception Mode (DRX) after a period of inactivity. During this state, the device XT00 may power down for brief intervals of time and thus save power.

If there is no data traffic activity for an extended period of time, then the device XT00 may transition off to an RRC Idle state, where it disconnects from the network and does not perform operations such as channel quality feedback, handover, etc. The device XT00 goes into a very low power state and it performs paging where again it periodically wakes up to listen to the network and then powers down again. The device XT00 may not receive data in this state, in order to receive data, it must transition back to RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors, as further examples for the above control modules 14, 24, of the application circuitry XT02 and processors of the baseband circuitry XT04 may be used to execute elements of one or more instances of a protocol stack. For example, processors of the baseband circuitry XT04, alone or in combination, may be used execute Layer 3, Layer 2, or Layer 1 functionality, while processors of the application circuitry XT04 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 8 shows example interfaces 12, 22 of baseband circuitry as another example of an apparatus 10, 20 for a mobile device, user equipment, a network node or a NodeB. FIG. 8 illustrates example interfaces of baseband circuitry in accordance with some embodiments. As discussed above, the baseband circuitry XT04 of FIG. 7 may comprise processors XT04A-XT04E and a memory XT04G utilized by said processors. Each of the processors XT04A-XT04E may include a memory interface, XU04A-XU04E, respectively, to send/receive data to/from the memory XT04G.

The baseband circuitry XT04 may further include one or more interfaces 12, 22 to communicatively couple to other circuitries/devices, such as a memory interface XU12 (e.g., an interface to send/receive data to/from memory external to the baseband circuitry XT04), an application circuitry interface XU14 (e.g., an interface to send/receive data to/from the application circuitry XT02 of FIG. 7), an RF circuitry interface XU16 (e.g., an interface to send/receive data to/from RF circuitry XT06 of FIG. 7), a wireless hardware connectivity interface XU18 (e.g., an interface to send/receive data to/from Near Field Communication (NFC) components, Bluetooth® components (e.g., Bluetooth® Low Energy), Wi-Fi® components, and other communication components), and a power management interface XU20 (e.g., an interface to send/receive power or control signals to/from the PMC XT12).).

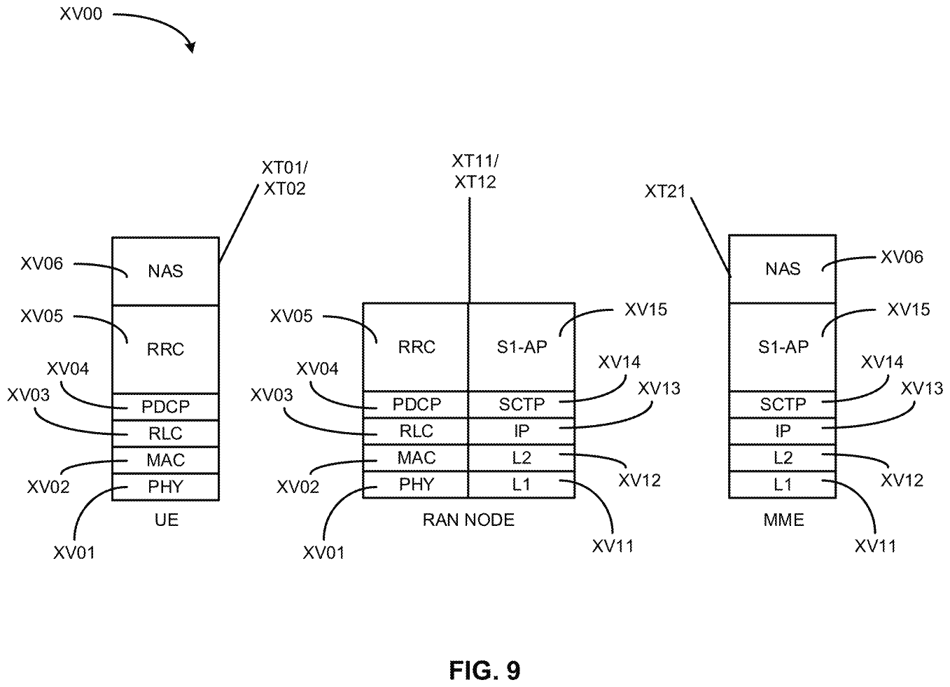

FIG. 9 shows a control plane protocol stack in an example. FIG. 9 is an illustration of a control plane protocol stack in accordance with some embodiments. In this embodiment, a control plane XV00 is shown as a communications protocol stack between the UE XS01 (or alternatively, the UE XS02), the RAN node XS11 (or alternatively, the RAN node XS12), and the MME XS21.

The PHY layer XV01 may transmit or receive information used by the MAC layer XV02 over one or more air interfaces. The PHY layer XV01 may further perform link adaptation or adaptive modulation and coding (AMC), power control, cell search (e.g., for initial synchronization and handover purposes), and other measurements used by higher layers, such as the RRC layer XV05. The PHY layer XV01 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer XV02 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARD), and logical channel prioritization.

The RLC layer XV03 may operate in a plurality of modes of operation, including: Transparent Mode (TM), Unacknowledged Mode (UM), and Acknowledged Mode (AM). The RLC layer XV03 may execute transfer of upper layer protocol data units (PDUs), error correction through automatic repeat request (ARQ) for AM data transfers, and concatenation, segmentation and reassembly of RLC SDUs for UM and AM data transfers. The RLC layer XV03 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer XV04 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer XV05 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE XS01 and the RAN node XS11 may utilize a Uu interface (e.g., an LTE-Uu interface) to exchange control plane data via a protocol stack comprising the PHY layer XV01, the MAC layer XV02, the RLC layer XV03, the PDCP layer XV04, and the RRC layer XV05.

The non-access stratum (NAS) protocols XV06 form the highest stratum of the control plane between the UE XS01 and the MME XS21. The NAS protocols XV06 support the mobility of the UE XS01 and the session management procedures to establish and maintain IP connectivity between the UE XS01 and the P-GW XS23.

The S1 Application Protocol (S1-AP) layer XV15 may support the functions of the S1 interface and comprise Elementary Procedures (EPs). An EP is a unit of interaction between the RAN node XS11 and the CN XS20. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) XV14 may ensure reliable delivery of signaling messages between the RAN node XS11 and the MME XS21 based, in part, on the IP protocol, supported by the IP layer XV13. The L2 layer XV12 and the L1 layer XV11 may refer to communication links (e.g., wired or wireless) used by the RAN node and the MME to exchange information.

The RAN node XS11 and the MME XS21 may utilize an S1-MME interface to exchange control plane data via a protocol stack comprising the L1 layer XV11, the L2 layer XV12, the IP layer XV13, the SCTP layer XV14, and the S1-AP layer XV15.

FIG. 10 shows a user plane protocol stack in an example. FIG. 10 is an illustration of a user plane protocol stack in accordance with some embodiments. In this embodiment, a user plane XW00 is shown as a communications protocol stack between the UE XS01 (or alternatively, the UE XS02), the RAN node XS11 (or alternatively, the RAN node XS12), the S-GW XS22, and the P-GW XS23. The user plane XW00 may utilize at least some of the same protocol layers as the control plane XV00. For example, the UE XS01 and the RAN node XS11 may utilize a Uu interface (e.g., an LTE-Uu interface) to exchange user plane data via a protocol stack comprising the PHY layer XV01, the MAC layer XV02, the RLC layer XV03, the PDCP layer XV04.

The General Packet Radio Service (GPRS) Tunneling Protocol for the user plane (GTP-U) layer W04 may be used for carrying user data within the GPRS core network and between the radio access network and the core network. The user data transported can be packets in any of IPv4, IPv6, or PPP formats, for example. The UDP and IP security (UDP/IP) layer XW03 may provide checksums for data integrity, port numbers for addressing different functions at the source and destination, and encryption and authentication on the selected data flows. The RAN node XS11 and the S-GW XS22 may utilize an S1-U interface to exchange user plane data via a protocol stack comprising the L1 layer XV11, the L2 layer XV12, the UDP/IP layer XW03, and the GTP—U layer XW04. The S-GW XS22 and the P-GW XS23 may utilize an S5/S8a interface to exchange user plane data via a protocol stack comprising the L1 layer XV11, the L2 layer XV12, the UDP/IP layer XW03, and the GTP—U layer W04. As discussed above with respect to FIG. 9, NAS protocols support the mobility of the UE XS01 and the session management procedures to establish and maintain IP connectivity between the UE XS01 and the P-GW XS23.

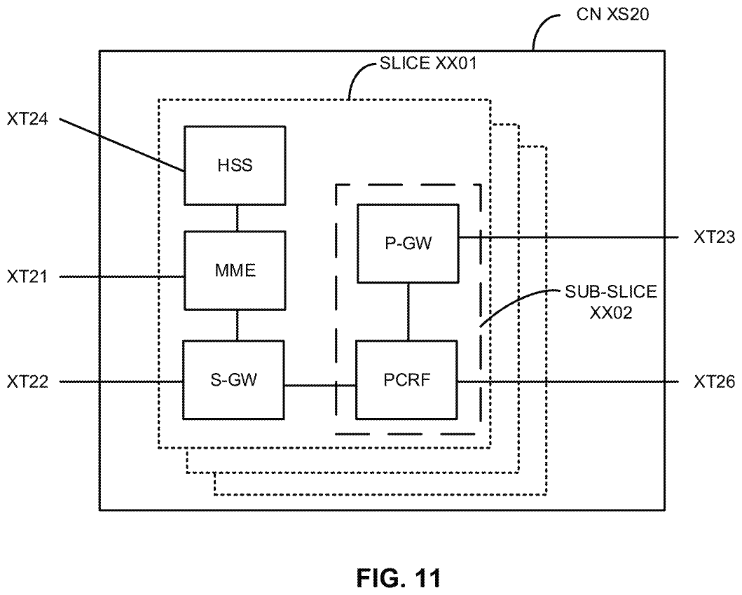

FIG. 11 illustrates core network components in an embodiment. FIG. 11 illustrates components of a core network in accordance with some embodiments. The components of the CN XS20 may be implemented in one physical node or separate physical nodes including components to read and execute instructions from a machine-readable or computer-readable medium (e.g., a non-transitory machine-readable storage medium). In some embodiments, Network Functions Virtualization (NFV) is utilized to virtualize any or all of the above described network node functions via executable instructions stored in one or more computer readable storage mediums (described in further detail below). A logical instantiation of the CN XS20 may be referred to as a network slice XX01. A logical instantiation of a portion of the CN XS20 may be referred to as a network sub-slice XX02 (e.g., the network sub-slice XX02 is shown to include the PGW XS23 and the PCRF XS26).

NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

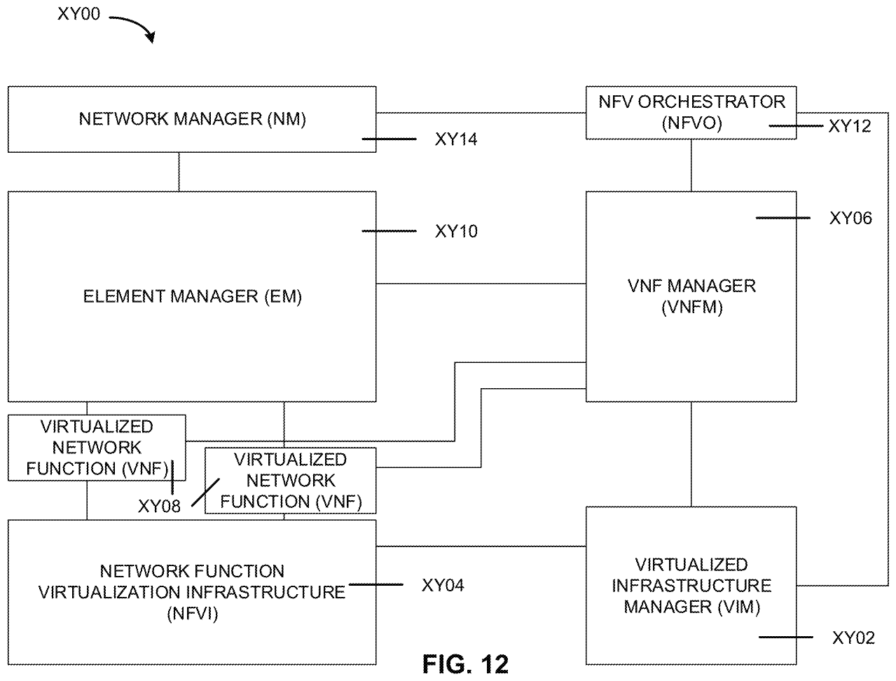

FIG. 12 illustrates an example of a system supporting network virtualization. FIG. 12 is a block diagram illustrating components, according to some example embodiments, of a system XY00 to support NFV. The system XY00 is illustrated as including a virtualized infrastructure manager (VIM) XY02, a network function virtualization infrastructure (NFVI) XY04, a VNF manager (VNFM) XY06, virtualized network functions (VNFs) XY08, an element manager (EM) XY10, an NFV Orchestrator (NFVO) XY12, and a network manager (NM) XY14.

The VIM XY02 manages the resources of the NFVI XY04. The NFVI XY04 can include physical or virtual resources and applications (including hypervisors) used to execute the system XY00. The VIM XY02 may manage the life cycle of virtual resources with the NFVI XY04 (e.g., creation, maintenance, and tear down of virtual machines (VMs) associated with one or more physical resources), track VM instances, track performance, fault and security of VM instances and associated physical resources, and expose VM instances and associated physical resources to other management systems.

The VNFM XY06 may manage the VNFs XY08. The VNFs XY08 may be used to execute EPC components/functions. The VNFM XY06 may manage the life cycle of the VNFs XY08 and track performance, fault and security of the virtual aspects of VNFs XY08. The EM XY10 may track the performance, fault and security of the functional aspects of VNFs XY08. The tracking data from the VNFM XY06 and the EM XY10 may comprise, for example, performance measurement (PM) data used by the VIM XY02 or the NFVI XY04. Both the VNFM XY06 and the EM XY10 can scale up/down the quantity of VNFs of the system XY00.

The NFVO XY12 may coordinate, authorize, release and engage resources of the NFVI XY04 in order to provide the requested service (e.g., to execute an EPC function, component, or slice). The NM XY14 may provide a package of end-user functions with the responsibility for the management of a network, which may include network elements with VNFs, non-virtualized network functions, or both (management of the VNFs may occur via the EM XY10).

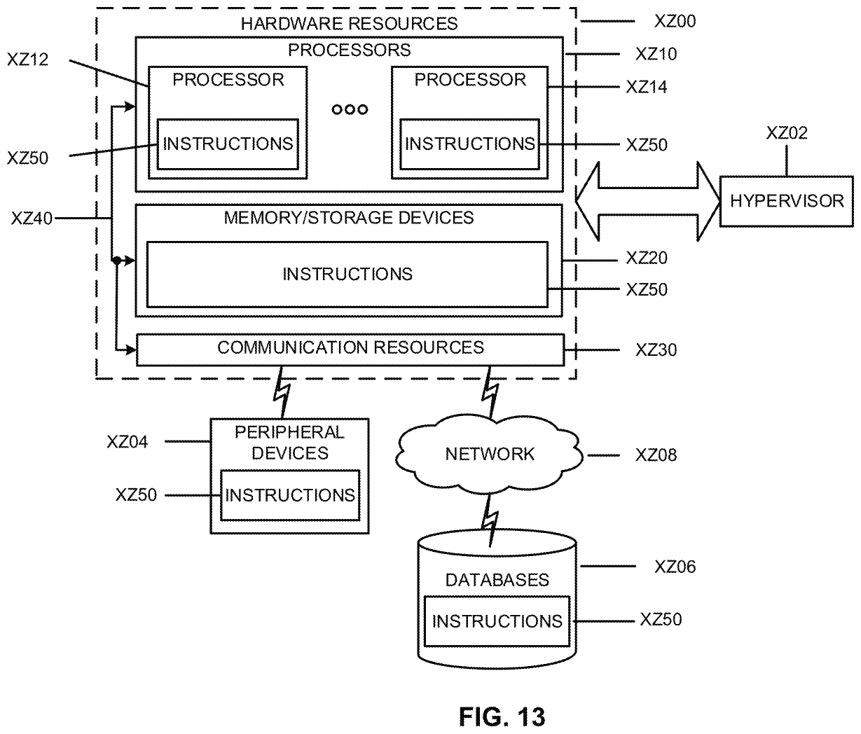

FIG. 13 illustrates component capable to read machine-readable instruction in an example. FIG. 13 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources XZ00 including one or more processors (or processor cores) XZ10, one or more memory/storage devices XZ20, and one or more communication resources XZ30, each of which may be communicatively coupled via a bus XZ40. For embodiments where node virtualization (e.g., NFV) is utilized, a hypervisor XZ02 may be executed to provide an execution environment for one or more network slices/sub-slices to utilize the hardware resources XZ00

The processors XZ10 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor XZ12 and a processor XZ14.

The memory/storage devices XZ20 may include main memory, disk storage, or any suitable combination thereof. The memory/storage devices XZ20 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources XZ30 may include interconnection or network interface components or other suitable devices to communicate with one or more peripheral devices XZ04 or one or more databases XZ06 via a network XZ08. For example, the communication resources XZ30 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions XZ50 may comprise software, a program, an application, an applet, an app, or other executable code for causing at least any of the processors XZ10 to perform any one or more of the methodologies discussed herein. The instructions XZ50 may reside, completely or partially, within at least one of the processors XZ10 (e.g., within the processor's cache memory), the memory/storage devices XZ20, or any suitable combination thereof. Furthermore, any portion of the instructions XZ50 may be transferred to the hardware resources XZ00 from any combination of the peripheral devices XZ04 or the databases XZ06. Accordingly, the memory of processors XZ10, the memory/storage devices XZ20, the peripheral devices XZ04, and the databases XZ06 are examples of computer-readable and machine-readable media.

The examples as described herein may be summarized as follows:

Example 1 is a method (30) for a mobile device (100) configured to communicate in a mobile communication system (400), the method (30) comprising receiving (32) reference signal configuration information at the mobile device (100), wherein the reference signal configuration information comprises information on a reference signal radio resource, the reference signal radio resource specifying at least one reference signal from a group of two or more reference signals, wherein the two or more reference signals in the group of two or more reference signals differ in at least one element of the group of a time-frequency resource, a sequence, and a cyclic shift, and enabling (34) measurements based on the at least one reference signal.

Example 2 is the method (30) of example 1, wherein the reference signal configuration information comprises information on an identification of the mobile device (100) or identification on a group of mobile devices.

Example 3 is the method (30) of one of the examples 1 or 2, further comprising receiving down-link control information from the mobile communication system (400), the downlink control information indicating to transmit the reference signal.

Example 4 is the method (30) of example 3, wherein the downlink control information signal addresses multiple mobile transceivers.

Example 5 is the method (30) of one of the examples 3 or 4, further comprising determining whether a cyclic redundancy check information of the downlink control information addresses the mobile device (100).

Example 6 is the method (30) of one of the examples 1 to 5, further comprising receiving information on transmitting the reference signal periodically or aperiodically.

Example 7 is the method (30) of one of the examples 1 to 6, further comprising receiving measurement report information comprising an indication on conducting a measurement on a reference signal of another mobile device.

Example 8 is the method (30) of example 7, wherein the measurement report information is comprised in downlink control information.

Example 9 is the method (30) of one of the examples 7 or 8, wherein the measurement report information comprises information on a measurement metric.

Example 10 is the method (30) of example 9, wherein the measurement metric comprises an indication whether a receive signal strength indicator or a reference signal receive power should be measured.

Example 11 is the method (30) of one of the examples 7 to 10, wherein the measurement report information comprises information on an identification of the reference signal to be measured.

Example 12 is the method (30) of one of the examples 7 to 11, further comprising switching measurement reports dynamically on and off.

Example 13 is the method (30) of one of the examples 7 to 12, wherein the measurement report information further comprises information on a bandwidth, which should be measured.

Example 14 is the method (30) of one of the examples 1 to 13, wherein the reference signal configuration information further comprises information on a periodicity of the reference signal.

Example 15 is the method (30) of one of the examples 1 to 14, wherein the reference signal configuration information comprises an index indexing preconfigured reference signal configurations.

Example 16 is the method (30) of one of the examples 1 to 15, wherein the reference signal configuration information further comprises information on a periodicity of a measurement reporting.

Example 17 is the method (30) of one of the examples 1 to 16, wherein the reference signal configuration information is signaled by means of radio resource control signaling of the mobile communication system (400).

Example 18 is a computer program having a program code for performing at least one of the methods (30) according to one of the examples 1 to 17, when the computer program is executed on a computer, a processor, or a programmable hardware component.

Example 19 is a machine readable storage including machine readable instructions, when executed, to implement at least one method (30) according to any of the examples 1 to 17, or realize an apparatus being configured to implement at least one method (30) according to any of the examples 1 to 17.

Example 20 is a machine readable medium including code, when executed, to cause a machine to perform at least one method (30) according to any of the examples 1 to 17.

Example 21 is a circuit (10) for a mobile device (100) configured to communicate in a mobile communication system (400), comprising one or more interfaces (12) configured to communicate within the mobile communication system (400), and a control module (14) configured to perform at least one method (30) according to any of the examples 1 to 17.

For example, the one or more interfaces (12) are the RF interface XU16 in FIG. 8 and the control module (14) is the CPU XT04E in FIGS. 8, 9.

Example 22 is an apparatus (10) for a user equipment, UE (100), configured to communicate in a mobile communication system (400), comprising one or more interfaces (12) configured to communicate within the mobile communication system (400), and a control module (14) configured to control the one or more interfaces (12), process reference signal configuration information received by the one or more interfaces (12), wherein the reference signal configuration information comprises information on a reference signal radio resource, the reference signal radio resource specifying at least one reference signal from a group of two or more reference signals, wherein the two or more reference signals differ in at least one element of the group of a time-frequency resource, a sequence, and a cyclic shift, and enable measurements based on the at least one reference signal.

Example 23 is the apparatus (10) of example 22, wherein the reference signal configuration information comprises information on an identification of the UE (100) or identification on a group of UEs.

Example 24 is the apparatus (10) of one of the examples 22 or 23, wherein the control module (14) is configured to obtain downlink control information from the mobile communication system (400) using the one or more interfaces (12), the downlink control information indicates to transmit the reference signal.

Example 25 is the apparatus (10) of example 24, wherein the downlink control information addresses multiple UEs.

Example 26 is the apparatus (10) of one of the examples 24 or 25, wherein the control module (14) is configured to determine whether a cyclic redundancy check information of the downlink control information addresses the UE (100).

Example 27 is the apparatus (10) of one of the examples 22 to 26, wherein the control module (14) is configured to obtain information on transmitting the reference signal periodically or aperiodically using the one or more interfaces (12).

Example 28 is the apparatus (10) of one of the examples 22 to 27, wherein the control module (14) is configured to obtain, using the one or more interfaces (12), measurement report information comprising an indication on conducting a measurement on a reference signal of another UE.

Example 29 is the apparatus (10) of example 28, wherein the measurement report information is comprised in downlink control information.

Example 30 is the apparatus (10) of one of the examples 28 or 29, wherein the measurement report information comprises information on a measurement metric.

Example 31 is the apparatus (10) of example 30, wherein the measurement metric comprises an indication whether a receive signal strength indicator or a reference signal receive power should be measured.

Example 32 is the apparatus (10) of one of the examples 28 to 31, wherein the measurement report information comprises information on an identification of the reference signal to be measured.

Example 33 is the apparatus (10) of one of the examples 28 to 32, wherein the control module (14) is configured to switch the measurement reports dynamically on and off.

Example 34 is the apparatus (10) of one of the examples 28 to 33, wherein the measurement report information further comprises information on a bandwidth, which should be measured.

Example 35 is the apparatus (10) of one of the examples 22 to 34, wherein the reference signal configuration information further comprises information on a periodicity of the reference signal.

Example 36 is the apparatus (10) of one of the examples 22 to 35, wherein the reference signal configuration information comprises an index indexing preconfigured reference signal configurations.

Example 37 is the apparatus (10) of one of the examples 22 to 36, wherein the reference signal configuration information further comprises information on a periodicity of a measurement reporting.

Example 38 is the apparatus (10) of one of the examples 22 to 37, wherein the reference signal configuration information is signaled by means of radio resource control signaling of the mobile communication system (400).

Example 39 is an apparatus (10) for user equipment, UE (100), comprising means for communicating (12) in a mobile communication system (400); means for obtaining (14) reference signal configuration information at the UE (100), the reference signal configuration information comprising information on a reference signal radio resource, the reference signal radio resource specifying at least one reference signal from a group of two or more reference signals, wherein the two or more reference signals in the group of two or more reference signals differ in at least one element of the group of a time-frequency resource, a sequence, and a cyclic shift; and means for enabling (14) measurements based on the at least one reference signal. For example, the means for communicating (12) is the RF interface XU16 in FIG. 8 and the means for obtaining/enabling (14) is the CPU XT04E in FIGS. 8, 9.

Example 40 is the apparatus (10) of example 39 comprising means for performing any method (30) step of one of the examples 1 to 17.

Example 41 is User Equipment (100) comprising the apparatus (10) or circuit (10) of any of the examples 21 to 40.

Example 42 is a mobile device (100) comprising the apparatus (10) or circuit (10) of any of the examples 21 to 38.

Example 43 is a method (40) for a network node (200) configured to communicate in a mobile communication system (400), the method (40) comprising generating (42) reference signal configuration information for a mobile device (100), the reference signal configuration information comprising information on a reference signal radio resource, the reference signal radio resource specifying at least one reference signal from a group of two or more reference signals, wherein the two or more reference signals in the group of two or more reference signals differ in at least one element of the group of a time-frequency resource, a sequence, and a cyclic shift, and configuring (44) measurements based on the at least one reference signal.

Example 44 is the method (40) of example 43, wherein the reference signal configuration information comprises information on an identification of the mobile device (100) or identification on a group of mobile devices.

Example 45 is the method (40) of one of the examples 43 or 44, the method further comprising transmitting downlink control information from the network node (200) of the mobile communication system (400) to the mobile device (100), the downlink control information indicating to at least one mobile device (100) to transmit the reference signal.

Example 46 is the method (40) of example 45, wherein the downlink reference signal addresses multiple mobile transceivers.

Example 47 is the method (40) of one of the examples 45 or 46, further comprising addressing the mobile device (100) using cyclic redundancy check information of the downlink control information.

Example 48 is the method (40) of one of the examples 43 to 47, further comprising transmitting information on transmitting the reference signal periodically or aperiodically.

Example 49 is the method (40) of one of the examples 43 to 48, further comprising transmitting measurement report information comprising an indication on conducting a measurement on a reference signal of another mobile device.

Example 50 is the method (40) of example 49, wherein the measurement report information is comprised in downlink control information.

Example 51 is the method (40) of one of the examples 49 or 50, wherein the measurement report information comprises information on a measurement metric.

Example 52 is the method (40) of example 51, wherein the measurement metric comprises an indication whether a receive signal strength indicator or a reference signal receive power should be measured.

Example 53 is the method (40) of one of the examples 49 to 52, wherein the measurement report information comprises information on an identification of the reference signal to be measured.

Example 54 is the method (40) of one of the examples 49 to 53, further comprising switching measurement reports dynamically on and off.

Example 55 is the method (40) of one of the examples 49 to 54, wherein the measurement report information further comprises information on a bandwidth, which should be measured.

Example 56 is the method (40) of one of the examples 43 to 55, wherein the reference signal configuration information further comprises information on a periodicity of the reference signal.

Example 57 is the method (40) of one of the examples 43 to 56, wherein the reference signal configuration information comprises an index indexing preconfigured reference signal configurations.

Example 58 is the method (40) of one of the examples 43 to 57, wherein the reference signal configuration information further comprises information on a periodicity of a measurement reporting.

Example 59 is the method (40) of one of the examples 43 to 58, wherein the reference signal configuration information is signaled by means of radio resource control signaling of the mobile communication system (400).

Example 60 is a computer program having a program code for performing at least one of the methods (40) according to any of the examples 43 to 59, when the computer program is executed on a computer, a processor, or a programmable hardware component.

Example 61 is a machine readable storage including machine readable instructions, when executed, to implement at least one method (40) according to any of the examples 43 to 59, or realize an apparatus being configured to implement at least one method according to any of the examples 43 to 59.

Example 62 is a machine readable medium including code, when executed, to cause a machine to perform at least one method (40) according to any of the examples 43 to 59.

Example 63 is a circuit (20) for a for a network node (200) configured to communicate in a mobile communication system (400), comprising one or more interfaces (22) to communicate within the mobile communication system (400); and a control module (24) configured to perform at least one method (40) according to any of the examples 43 to 59. For example, the one or more interfaces (22) are the RF interface XU16 in FIG. 8 and the control module (24) is the CPU XT04E in FIGS. 8, 9.

64. An apparatus (20) for a network node (200) configured to communicate in a mobile communication system (400), comprising one or more interfaces (22) to communicate within the mobile communication system (400), and a control module (24) configured to control the one or more interfaces (22), generate reference signal configuration information for a User Equipment, UE (100), the reference signal configuration information comprises information on a reference signal radio resource, the reference signal radio resource specifies at least one reference signal from a group of two or more reference signals, wherein the two or more reference signals differ in at least one element of the group of a time-frequency resource, a sequence, and a cyclic shift, and configure measurements based on the at least one reference signal using the one or more interfaces (22). For example, the one or more interfaces (22) are the RF interface XU16 in FIG. 8 and the control module (24) is the CPU XT04E in FIGS. 8, 9.

Example 65 is the apparatus (20) of example 64, wherein the reference signal configuration information comprises information on an identification of the UE (100) or identification on a group of UEs.

Example 66 is the apparatus (20) of one of the examples 64 or 65, wherein the control module (24) is configured to provide downlink control information to the one or more interfaces (22) for transmission from the network node (200) of the mobile communication system (400) to the UE (100), the downlink control information indicating to at least one UE (100) to transmit the reference signal.

Example 67 is the apparatus (20) of example 66, wherein the downlink reference signal addresses multiple UEs.

Example 68 is the apparatus (20) of one of the examples 66 or 67, wherein the control module (24) is further configured to address the UE (100) using cyclic redundancy check information of the downlink control information.

Example 69 is the apparatus (20) of one of the examples 64 to 68, wherein the control module (24) is configured to provide information on transmitting the reference signal periodically or aperiodically to the one or more interfaces (22) for transmission.

Example 70 is the apparatus (20) of one of the examples 64 to 69, wherein the control module (24) is configured to generate measurement report information comprising an indication on conducting a measurement on a reference signal of another UE.

Example 71 is the apparatus (20) of example 70, wherein the measurement report information is comprised in downlink control information.

Example 72 is the apparatus (20) of one of the examples 70 or 71, wherein the measurement report information comprises information on a measurement metric.

Example 73 is the apparatus (20) of example 72, wherein the measurement metric comprises an indication whether a receive signal strength indicator or a reference signal receive power should be measured.

Example 74 is the apparatus (20) of one of the examples 70 to 73, wherein the measurement report information comprises information on an identification of the reference signal to be measured.

Example 75 is the apparatus (20) of one of the examples 70 to 74, wherein the control module (24) is configured to switch measurement reports dynamically on and off.

Example 76 is the apparatus (20) of one of the examples 70 to 75, wherein the measurement report information further comprises information on a bandwidth, which should be measured.

Example 77 is the apparatus (20) of one of the examples 64 to 76, wherein the reference signal configuration information further comprises information on a periodicity of the reference signal.

Example 78 is the apparatus (20) of one of the examples 64 to 77, wherein the reference signal configuration information comprises an index indexing preconfigured reference signal configurations.

Example 79 is the apparatus (20) of one of the examples 64 to 78, wherein the reference signal configuration information further comprises information on a periodicity of a measurement reporting.

Example 80 is the apparatus (20) of one of the examples 64 to 79, wherein the reference signal configuration information is signaled by means of radio resource control signaling of the mobile communication system (400).

Example 81 is an apparatus (20) for a network node (200), comprising means for communicating (22) in a mobile communication system (400); means for generating (24) reference signal configuration information for a mobile device (100), the reference signal configuration information comprising information on a reference signal radio resource, the reference signal radio resource specifying at least one reference signal from a group of two or more reference signals, wherein the two or more reference signals in the group of two or more reference signals differ in at least one element of the group of a time-frequency resource, a sequence, and a cyclic shift; and means for configuring (24) measurements based on the at least one reference signal. For example, the means for communicating (22) are the RF interface XU16 in FIG. 8 and the means for generating/configuring (24) is the CPU XT04E in FIGS. 8, 9.

Example 82 is the apparatus (20) of example 81, comprising means for performing any method (40) step of one of the examples 43 to 59.

Example 83 is a network node (200) comprising the apparatus (20) or circuit (20) of any of the examples 63 to 82.

Example 84 is a NodeB or gNodeB (200) comprising the apparatus (20) or circuit (20) of any of the examples 63 to 82.

Example 85 is a mobile communication system (400) comprising at least one user equipment (100) according to example 41 and at least one network node (200) according to example 83.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, may be implemented in the form of dedicated hardware, such as “a signal provider”, “a signal processing unit”, “a processor”, “a controller”, as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1.-25. (canceled)

26. An apparatus for a user equipment (UE), the apparatus configured to communicate in a mobile communication system and comprising:
one or more interfaces configured to communicate within the mobile communication system; and
a control module configured to:
control the one or more interfaces;
process reference signal configuration information received by the one or more interfaces, wherein the reference signal configuration information comprises information on a reference signal radio resource, the reference signal radio resource specifying at least one reference signal from a group of two or more reference signals, wherein the two or more reference signals differ in at least one element of the group of a time-frequency resource, a sequence, and a cyclic shift; and
enable measurements based on the at least one reference signal.

27. The apparatus of claim 26, wherein the reference signal configuration information comprises information on an identification of the UE or identification on a group of UEs.

28. The apparatus of claim 26, wherein the control module is configured to obtain downlink control information from the mobile communication system using the one or more interfaces, wherein the downlink control information indicates that the reference signal is to be transmitted.

29. The apparatus of claim 28, wherein the downlink control information addresses multiple UEs.

30. The apparatus of claim 28, wherein the control module is configured to determine whether a cyclic redundancy check information of the downlink control information addresses the UE.

31. The apparatus of claim 26, wherein the control module is configured to obtain information on transmitting the reference signal periodically or aperiodically using the one or more interfaces.

32. The apparatus of claim 26, wherein the control module is configured to obtain, using the one or more interfaces, measurement report information comprising an indication on conducting a measurement on a reference signal of another UE.

33. The apparatus of claim 32, wherein the measurement report information is comprised in downlink control information.

34. The apparatus of claim 32, wherein the measurement report information comprises information on a measurement metric.

35. The apparatus of claim 34, wherein the measurement metric comprises an indication whether a receive signal strength indicator or a reference signal receive power should be measured.

36. The apparatus of claim 32, wherein the measurement report information comprises information on an identification of the reference signal to be measured.

37. The apparatus of claim 32, wherein the control module is configured to switch the measurement reports dynamically on and off.

38. The apparatus of claim 32, wherein the measurement report information further comprises information on a bandwidth, which should be measured.

39. The apparatus of claim 26, wherein the reference signal configuration information further comprises information on a periodicity of the reference signal.

40. The apparatus of claim 26, wherein the reference signal configuration information comprises an index indexing preconfigured reference signal configurations.

41. The apparatus of claim 26, wherein the reference signal configuration information further comprises information on a periodicity of a measurement reporting.

42. The apparatus of claim 26, wherein the reference signal configuration information is signaled by means of radio resource control signaling of the mobile communication system.

43. A device comprising:
radio frequency circuit configured to enable communication of the device with one or more radio networks;
one or more interfaces configured to communicate within the device; and
a control module communicatively coupled to the radio frequency circuit and the one or more interfaces, and configured to:
process reference signal configuration information received by the one or more interfaces through the radio frequency circuit, wherein the reference signal configuration information comprises information on a reference signal radio resource, the reference signal radio resource specifying at least one reference signal from a group of two or more reference signals, wherein the two or more reference signals differ in at least one element of the group of a time-frequency resource, a sequence, and a cyclic shift; and
enable measurements based on the at least one reference signal.

44. An apparatus for a network node configured to communicate in a mobile communication system, the network node comprising:
one or more interfaces to communicate within the mobile communication system; and
a control module configured to:
control the one or more interfaces;
generate reference signal configuration information for a User Equipment (UE), wherein the reference signal configuration information comprises information on a reference signal radio resource, wherein the reference signal radio resource specifies at least one reference signal from a group of two or more reference signals, wherein the two or more reference signals differ in at least one element of the group of: a time-frequency resource, a sequence, or a cyclic shift; and
configure measurements based on the at least one reference signal using the one or more interfaces.

45. The apparatus of claim 44, wherein the reference signal configuration information comprises information on an identification of the UE or identification on a group of UEs.
